(19) United States
(12) Patent Application Publication
(10) Pub. No.: US 2024/0224186 A1
(43) Pub. Date: Jul. 4, 2024

(54) WI-FI LINK SLEEP AND WAKE-UP METHOD, ELECTRONIC DEVICE, AND SYSTEM

(71) Applicant: HUAWEI TECHNOLOGIES CO., LTD., Shenzhen, Guangdong (CN)

(72) Inventors: Ming ZHOU, Shanghai (CN); Li ZHANG, Wuhan (CN); Ming YANG, Shanghai (CN); Jianhua YANG, Shanghai (CN)

(21) Appl. No.: 18/556,223

(22) PCT Filed: Apr. 7, 2022
(86) PCT No.: PCT/CN2022/085433

§ 371 Date: Oct. 19, 2023

(30) Foreign Application Priority Data
Apr. 22, 2021 (CN) 202110438318.8

(51) Int. Cl. H04W 52/02; H04W 76/10

(52) U.S. Cl. CPC H04W 52/0235; H04W 52/0216; H04W 52/0274; H04W 76/10

(57) ABSTRACT

The present disclosure relates to Wi-Fi link sleep and wake-up methods, electronic devices, and systems. In one example method, a first electronic device establishes a Wi-Fi direct link with a second electronic device. The first electronic device is a group owner (GO) of Wi-Fi Direct. The second electronic device is a group client (GC) of Wi-Fi Direct. The second electronic device may send a first request message to the first electronic device to trigger the first electronic device to enable Wi-Fi link sleep. When a wireless projection service is suspended, a Wi-Fi link used for wireless projection enters a low-power state in a timely manner. When the Wi-Fi direct link sleeps, the second electronic device may send a wake-up request message to the first electronic device to trigger the first electronic device to wake up the Wi-Fi link.

This application claims priority to Chinese Patent Application No. 202110438318.8, filed with the China National Intellectual Property Administration on Apr. 22, 2021, and entitled “Wi-Fi LINK SLEEP AND WAKE-UP METHOD, ELECTRONIC DEVICE, AND SYSTEM”, which is incorporated herein by reference in its entirety.

### TECHNICAL FIELD

This application relates to the field of short-range communication, and in particular, to a Wi-Fi link sleep and wake-up method, an electronic device, and a system.

### BACKGROUND

With development of wireless projection technologies, the wireless projection technologies become more and more widely used. For example, a user may wirelessly project an interface of a mobile phone to a display of a mobile screen, to implement multi-screen collaboration between the mobile phone and the mobile screen. The mobile phone and the mobile screen are connected through wireless fidelity (wireless fidelity, Wi-Fi). The mobile phone is a source end of wireless projection, and the mobile screen is a receiving end of wireless projection.

In some scenarios, as shown in FIG. 1A-1 and FIG. 1A-2, when a screen of the mobile phone is turned off after a power button of the mobile phone is pressed or turned off because the mobile phone is not operated in a long time, a wireless projection service is suspended. In some other scenarios, as shown in FIG. 1B-1 and FIG. 1B-2, when the mobile screen is turned off after a power button of the mobile screen is pressed or turned off because the mobile screen is not operated in a long time, the wireless projection service is suspended.

When the wireless projection service is suspended, a Wi-Fi link used for wireless projection needs to enter a low-power state (that is, sleep) to save energy on a device. When the user operates the mobile phone or the mobile screen again (for example, presses the power button or picks up the mobile screen), the screen of the mobile phone or the mobile screen is turned on. In this case, the Wi-Fi link used for wireless projection needs to be woken up in a timely manner to exit from the low-power state and enter a working state, so as to resume the wireless projection service.

Therefore, the following problem needs to be resolved: how to enable the Wi-Fi link used for wireless projection to enter the low-power state in a timely manner when the wireless projection service is suspended; and how to enable the Wi-Fi link used for wireless projection to exit from the low-power state with a low latency when the user operates the mobile phone or the mobile screen again.

### SUMMARY

Embodiments of this application provide a Wi-Fi link sleep and wake-up method, an electronic device, and a system. In this way, when a wireless projection service is suspended, a Wi-Fi link used for wireless projection may enter a low-power state in a timely manner; and when a user operates a mobile phone or a mobile screen again, the Wi-Fi link used for wireless projection exits from the low-power state with a low latency, and the wireless projection service is quickly resumed.

To achieve the foregoing objectives, this application uses the following technical solutions.

According to a first aspect, this application provides a Wi-Fi link sleep method, which is applied to a first electronic device. The first electronic device establishes a wireless fidelity Wi-Fi direct link with a second electronic device. The first electronic device is a group owner GO of Wi-Fi Direct, and the second electronic device is a group client GC of Wi-Fi Direct. The method includes: The first electronic device receives a first request message, where the first request message is used to trigger the first electronic device to enable Wi-Fi link sleep; the first electronic device sends a first message to the second electronic device, where the first message includes at least one of a sleep interval count, a sleep start time, an absent period, and a sleep interval; and the first electronic device enters a Wi-Fi link sleep state based on at least one of the sleep interval count, the sleep start time, the absent period, and the sleep interval. The sleep interval count indicates a quantity of times the Wi-Fi link enters a sleep window in a current sleep process, and the Wi-Fi link does not perform data transmission in the sleep window. The sleep start time indicates a start moment at which the Wi-Fi link enters the sleep window for a first time in the current sleep process. The absent period indicates duration in which the Wi-Fi link remains in the sleep window in the current sleep process. The sleep interval indicates a time interval at which the Wi-Fi link enters the sleep window in the current sleep process.

In this method, when a second preset condition is met (for example, a screen of the GC is turned off), the GC triggers the GO to enable Wi-Fi direct link sleep, and does not need to wait for the GO to initiatively enable Wi-Fi direct link sleep. The Wi-Fi direct link may enter the sleep state more quickly, thereby saving energy on a device.

With reference to the first aspect, in a possible design, the first request message is a link layer message. For example, the first request message is a first management (action) frame. The first management (action) frame is a custom action frame in the 802.11 protocol. In a possible design, the first request message is a service layer message. For example, the first request message is a projection suspension request message, and is used to request to suspend transmission of wireless projection data.

With reference to the first aspect, in a possible design, the first message is a first beacon frame, and the sleep interval count in the first beacon frame is greater than 0. If the sleep interval count is greater than 0, it indicates that Wi-Fi direct link sleep is enabled.

With reference to the first aspect, in a possible design, that the first electronic device sends a first message to the second electronic device includes: The first electronic device sends the first message to the second electronic device in a next beacon frame interval after the first request message is received.

According to a second aspect, this application provides a Wi-Fi link sleep method, which is applied to a second electronic device. The second electronic device establishes a wireless fidelity Wi-Fi direct link with a first electronic device. The first electronic device is a group owner GO of Wi-Fi Direct, and the second electronic device is a group client GC of Wi-Fi Direct. The method includes: The second electronic device sends a first request message to the first electronic device, where the first request message is used to trigger the first electronic device to enable Wi-Fi link sleep; the second electronic device receives a first message, where the first message includes at least one of a sleep interval count, a sleep start time, an absent period, and a sleep interval; and the second electronic device enters a Wi-Fi link sleep state based on at least one of the sleep interval count, the sleep start time, the absent period, and the sleep interval. The sleep interval count indicates a quantity of times the Wi-Fi link enters a sleep window in a current sleep process, and the Wi-Fi link does not perform data transmission in the sleep window. The sleep start time indicates a start moment at which the Wi-Fi link enters the sleep window for a first time in the current sleep process. The absent period indicates duration in which the Wi-Fi link remains in the sleep window in the current sleep process. The sleep interval indicates a time interval at which the Wi-Fi link enters the sleep window in the current sleep process.

In this method, when a second preset condition is met (for example, a screen of the GC is turned off), the GC triggers the GO to enable Wi-Fi direct link sleep, and does not need to wait for the GO to initiatively enable Wi-Fi direct link sleep. The Wi-Fi direct link may enter the sleep state more quickly, thereby saving energy on a device.

With reference to the second aspect, in a possible design, the first request message is a link layer message. For example, the first request message is a first management (action) frame. The first management (action) frame is a custom action frame in the 802.11 protocol. In a possible design, the first request message is a service layer message. For example, the first request message is a projection suspension request message, and is used to request to suspend transmission of wireless projection data.

With reference to the second aspect, in a possible design, the first message is a first beacon frame, and the sleep interval count in the first beacon frame is greater than 0. If the sleep interval count is greater than 0, it indicates that Wi-Fi direct link sleep is enabled.

With reference to the second aspect, in a possible design, before the second electronic device sends the first request message to the first electronic device, a screen of the second electronic device is turned off. In other words, when the screen of the second electronic device is turned off, the second electronic device sends the first request message to the first electronic device, to trigger the first electronic device (GO) to enable Wi-Fi direct link sleep.

According to a third aspect, this application provides a Wi-Fi link wake-up method, which is applied to a first electronic device. The first electronic device establishes a wireless fidelity Wi-Fi direct link with a second electronic device. The Wi-Fi direct link sleeps. The method includes: The first electronic device receives a wake-up request message, where the wake-up request message is used to trigger the first electronic device to wake up the Wi-Fi link; the first electronic device sends a wake-up message to the second electronic device, where the wake-up message is used to notify the second electronic device to exit from a Wi-Fi link sleep state; and the first electronic device exits from the Wi-Fi link sleep state.

In this method, when a fourth preset condition is met (for example, a screen of a GC is turned on), the GC triggers a GO to wake up the Wi-Fi direct link, and does not need to wait for the GO to initiatively wake up the Wi-Fi direct link. Alternatively, the GC may initiatively wake up the Wi-Fi direct link. In this way, the Wi-Fi direct link can be woken up with a low latency.

With reference to the third aspect, in a possible design, the method further includes: The first electronic device establishes a Bluetooth low energy BLE connection with the second electronic device. In this way, the first electronic device receives a first BLE request message from the second electronic device through the BLE connection. The first BLE request message includes first indication information, and the first indication information is used to trigger the first electronic device to wake up the Wi-Fi link.

In an implementation, after the first electronic device establishes the BLE connection with the second electronic device, the first electronic device is a BLE slave device and the second electronic device is a BLE master device. The second electronic device periodically sends first BLE request messages to the first electronic device. When the fourth preset condition is met, the second electronic device includes first indication information in the first BLE request message that is sent to the first electronic device. The first indication information is used to trigger the first electronic device to wake up the Wi-Fi link.

In another implementation, after the first electronic device establishes the BLE connection with the second electronic device, when the fourth preset condition is met, the second electronic device sends a first BLE indication message to the first electronic device. The first BLE indication message is used to trigger the first electronic device to wake up the Wi-Fi link.

In this method, the first indication information (the first BLE request message) is sent through the BLE connection, and the first indication information may also be successfully sent in a sleep window of the Wi-Fi direct link. Sending of the first BLE request message is not limited by the sleep window, and even if the sleep window is set to relatively long duration, wake-up of the Wi-Fi direct link with a low latency is not affected. In addition, setting the sleep window to relatively long duration may further reduce power consumption. In this way, power consumption can be reduced as much as possible, and wake-up of the Wi-Fi direct link with the low latency can be ensured.

With reference to the third aspect, in a possible design, the method further includes: The first electronic device establishes a Bluetooth low energy BLE connection with the second electronic device; and the first electronic device receives a first BLE response message through the BLE connection. The first BLE response message includes first indication information, and the first indication information is used to trigger the first electronic device to wake up the Wi-Fi link. The first BLE response message is sent in response to a first BLE request message, which is sent by the first electronic device to the second electronic device.

In an implementation, after the first electronic device establishes the BLE connection with the second electronic device, the first electronic device is a BLE master device and the second electronic device is a BLE slave device. The first electronic device periodically sends first BLE request messages to the second electronic device. Each time the second electronic device receives the first BLE request message, the second electronic device sends the first BLE response message to the first electronic device. When the fourth preset condition is met, the second electronic device includes first indication information in the first BLE response message that is sent to the first electronic device. The first indication information is used to trigger the first electronic device to wake up the Wi-Fi link.

In this method, the first indication information (the first BLE response message) is sent through the BLE connection, and the first indication information may also be successfully sent in a sleep window of the Wi-Fi direct link. Sending of the first BLE response message is not limited by the sleep window, and even if the sleep window is set to relatively long duration, wake-up of the Wi-Fi direct link with a low latency is not affected. In addition, setting the sleep window to relatively long duration may further reduce power consumption. In this way, power consumption can be reduced as much as possible, and wake-up of the Wi-Fi direct link with the low latency can be ensured.

With reference to the third aspect, in a possible design, the wake-up request message is a Bluetooth low energy BLE directed broadcast message. In this method, the first electronic device does not need to establish a BLE connection with the second electronic device. The GC triggers the GO to wake up the Wi-Fi direct link through a BLE directed broadcast. In the sleep window of the Wi-Fi direct link, the BLE directed broadcast message may also be successfully sent. In this way, the GC may also initiatively trigger wake-up of the Wi-Fi direct link, instead of waiting for the GO to wake up the Wi-Fi direct link. This reduces a latency in waking up the Wi-Fi direct link, and a wireless projection service may be resumed with a low latency. In addition, the sleep window may be set to relatively long duration, which not only ensures power consumption reduction, but also does not affect the wake-up of the Wi-Fi direct link with the low latency.

With reference to the third aspect, in a possible design, the wake-up request message is a link layer message or a service layer message. The wake-up request message cannot be sent in the sleep window of the Wi-Fi direct link, and may be successfully sent and received in a non-sleep window of the Wi-Fi direct link. In this method, the wake-up request message is sent in the non-sleep window in a low-power state of the Wi-Fi direct link, to trigger the GO to wake up the Wi-Fi direct link; and even if the GO and the GC do not support BLE, the GC may also initiatively trigger wake-up of the Wi-Fi direct link.

With reference to the third aspect, in a possible design, that the first electronic device sends a wake-up message to the second electronic device includes: The first electronic device sends the wake-up message to the second electronic device in a next beacon frame interval after the wake-up request message is received.

With reference to the third aspect, in a possible design, the wake-up message includes a sleep interval count. The sleep interval count indicates a quantity of times the Wi-Fi link enters a sleep window in a current sleep process, and the Wi-Fi link does not perform data transmission in the sleep window. The sleep interval count in the wake-up message is 0, indicating exit from the low-power state of the Wi-Fi direct link.

According to a fourth aspect, this application provides a Wi-Fi link wake-up method, which is applied to a second electronic device. The second electronic device establishes a wireless fidelity Wi-Fi direct link with a first electronic device. The Wi-Fi direct link sleeps. The method includes: The second electronic device sends a wake-up request message to the first electronic device, where the wake-up request message is used to trigger the first electronic device to wake up the Wi-Fi link; the second electronic device receives a wake-up message, where the wake-up message is used to notify the second electronic device to exit from Wi-Fi link sleep; and the second electronic device exits from a Wi-Fi link sleep state in response to the wake-up message.

In this method, when a fourth preset condition is met (for example, a screen of a GC is turned on), the GC triggers a GO to wake up the Wi-Fi direct link, and does not need to wait for the GO to initiatively wake up the Wi-Fi direct link. Alternatively, the GC may initiatively wake up the Wi-Fi direct link. In this way, the Wi-Fi direct link can be woken up with a low latency.

With reference to the fourth aspect, in a possible design, the method further includes: The first electronic device establishes a Bluetooth low energy BLE connection with the second electronic device; and the second electronic device sends a first BLE request message to the first electronic device through the BLE connection. The first BLE request message includes first indication information, and the first indication information is used to trigger the first electronic device to wake up the Wi-Fi link.

In an implementation, after the first electronic device establishes the BLE connection with the second electronic device, in response to a first BLE request message received through the BLE connection, the second electronic device sends a first BLE response message to the first electronic device through the BLE connection. The first BLE response message includes first indication information, and the first indication information is used to trigger the first electronic device to wake up the Wi-Fi link.

In another implementation, after the first electronic device establishes the BLE connection with the second electronic device, when the fourth preset condition is met, the second electronic device sends a first BLE indication message to the first electronic device. The first BLE indication message is used to trigger the first electronic device to wake up the Wi-Fi link.

In this method, the first indication information (the first BLE request message) is sent through the BLE connection, and the first indication information may also be successfully sent in a sleep window of the Wi-Fi direct link. Sending of the first BLE request message is not limited by the sleep window, and even if the sleep window is set to relatively long duration, wake-up of the Wi-Fi direct link with a low latency is not affected. In addition, setting the sleep window to relatively long duration may further reduce power consumption. In this way, power consumption can be reduced as much as possible, and wake-up of the Wi-Fi direct link with the low latency can be ensured.

With reference to the fourth aspect, in a possible design, the method further includes: The first electronic device establishes a Bluetooth low energy BLE connection with the second electronic device, in response to a first BLE request message received through the BLE connection; and the second electronic device sends a first BLE response message to the first electronic device through the BLE connection. The first BLE response message includes first indication information, and the first indication information is used to trigger the first electronic device to wake up the Wi-Fi link.

In this method, the first indication information (the first BLE response message) is sent through the BLE connection, and the first indication information may also be successfully sent in a sleep window of the Wi-Fi direct link. Sending of the first BLE response message is not limited by the sleep window, and even if the sleep window is set to relatively long duration, wake-up of the Wi-Fi direct link with a low latency is not affected. In addition, setting the sleep window to relatively long duration may further reduce power consumption. In this way, power consumption can be reduced as much as possible, and wake-up of the Wi-Fi direct link with the low latency can be ensured.

With reference to the fourth aspect, in a possible design, the wake-up request message is a Bluetooth low energy BLE directed broadcast message. In this method, the first electronic device does not need to establish a BLE connection with the second electronic device. The GC triggers the GO to wake up the Wi-Fi direct link through a BLE directed broadcast. In the sleep window of the Wi-Fi direct link, the BLE directed broadcast message may also be successfully sent. In this way, the GC may also initiatively trigger wake-up of the Wi-Fi direct link, instead of waiting for the GO to wake up the Wi-Fi direct link. This reduces a latency in waking up the Wi-Fi direct link, and a wireless projection service may be resumed with a low latency. In addition, the sleep window may be set to relatively long duration, which not only ensures power consumption reduction, but also does not affect the wake-up of the Wi-Fi direct link with the low latency.

With reference to the fourth aspect, in a possible design, the wake-up request message is a link layer message or a service layer message. The wake-up request message cannot be sent in the sleep window of the Wi-Fi direct link, and may be successfully sent and received in a non-sleep window of the Wi-Fi direct link. In this method, the wake-up request message is sent in the non-sleep window in a low-power state of the Wi-Fi direct link, to trigger the GO to wake up the Wi-Fi direct link; and even if the GO and the GC do not support BLE, the GC may also initiatively trigger wake-up of the Wi-Fi direct link.

With reference to the fourth aspect, in a possible design, the wake-up message includes a sleep interval count. The sleep interval count indicates a quantity of times the Wi-Fi link enters a sleep window in a current sleep process, and the Wi-Fi link does not perform data transmission in the sleep window. The sleep interval count in the wake-up message is 0, indicating exit from the low-power state of the Wi-Fi direct link.

With reference to the fourth aspect, in a possible design, before the second electronic device sends the wake-up request message to the first electronic device, a screen of the second electronic device is turned on.

According to a fifth aspect, an embodiment of this application provides an electronic device. The electronic device may include a processor and a memory. The processor is configured to support the electronic device in performing a corresponding function in the method according to the first aspect or the third aspect. The memory may be coupled to the processor, and store program instructions and data that are necessary for the electronic device. In addition, the electronic device may further include a communication interface, configured to support communication between the electronic device and another electronic device. The communication interface may be a transceiver or a transceiver circuit.

According to a sixth aspect, an embodiment of this application provides an electronic device. The electronic device may include a processor and a memory. The processor is configured to support the electronic device in performing a corresponding function in the method according to the second aspect or the fourth aspect. The memory may be coupled to the processor, and store program instructions and data that are necessary for the electronic device. In addition, the electronic device may further include a communication interface, configured to support communication between the electronic device and another electronic device. The communication interface may be a transceiver or a transceiver circuit.

According to a seventh aspect, an embodiment of this application provides a computer-readable storage medium. The computer-readable storage medium includes computer instructions. When the computer instructions are run on an electronic device, the electronic device is enabled to perform the method according to any one of the foregoing aspects and the possible designs of the foregoing aspects.

According to an eighth aspect, an embodiment of this application provides a computer program product. When the computer program product is run on a computer, the computer is enabled to execute the method according to any one of the foregoing aspects and the possible designs of the foregoing aspects.

An embodiment of this application provides a communication system, including the electronic device configured to implement the method according to the first aspect or the third aspect and the electronic device configured to implement the method according to the second aspect or the fourth aspect.

Any electronic device, computer-readable storage medium, computer program product, or communication system provided above is configured to perform the corresponding foregoing-provided method. Therefore, for beneficial effects that can be achieved thereof, refer to the beneficial effects of the corresponding solution in the corresponding foregoing-provided method. Details are not described herein again.

### BRIEF DESCRIPTION OF DRAWINGS

FIG. 1A-1 to FIG. 1A-2 and FIG. 1B-1 to FIG. 1B-2 are schematic diagrams of scenarios to which a Wi-Fi link sleep and wake-up method is applicable according to an embodiment of this application;

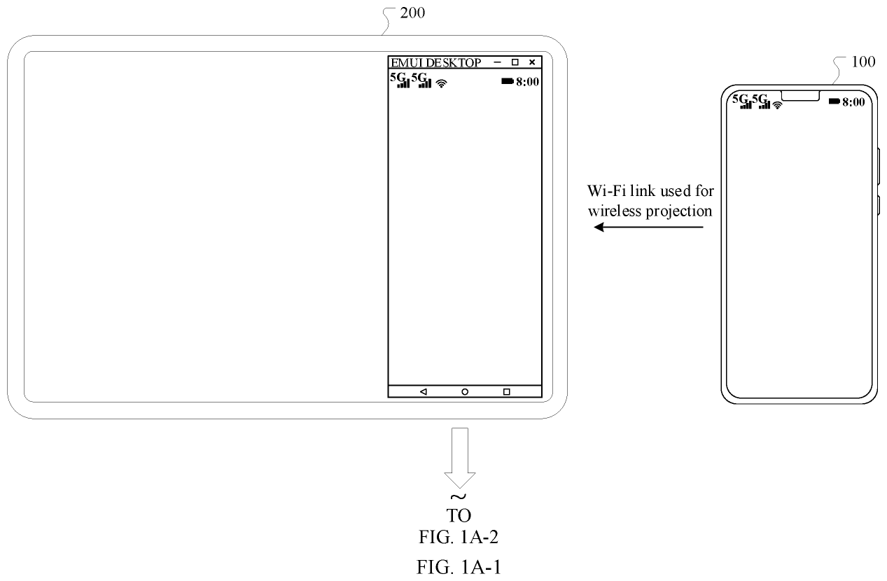

FIG. 2 is a schematic diagram of a system architecture to which a Wi-Fi link sleep and wake-up method is applicable according to an embodiment of this application;

FIG. 3 is a schematic diagram of a hardware structure of an electronic device according to an embodiment of this application;

FIG. 4 is a schematic flowchart of a method for entering and exiting from a low-power state by a Wi-Fi direct link in a Wi-Fi link sleep and wake-up method according to an embodiment of this application;

FIG. 5 is a schematic flowchart of a method for enabling Wi-Fi direct link sleep by a GO in a Wi-Fi link sleep and wake-up method according to an embodiment of this application;

FIG. 6A to FIG. 6C are instance diagrams of scenarios in which a GO enables Wi-Fi direct link sleep in a Wi-Fi link sleep and wake-up method according to an embodiment of this application;

FIG. 7 is a schematic flowchart of a method for enabling Wi-Fi direct link sleep by a GC in a Wi-Fi link sleep and wake-up method according to an embodiment of this application;

FIG. 8 is a schematic flowchart of a method for enabling Wi-Fi direct link sleep by a GC in a Wi-Fi link sleep and wake-up method according to an embodiment of this application;

FIG. 9 is an instance diagram of a scenario in which a GC enables Wi-Fi direct link sleep in a Wi-Fi link sleep and wake-up method according to an embodiment of this application;

FIG. 10 is a schematic flowchart of a method for waking up a Wi-Fi direct link by a GO in a Wi-Fi link sleep and wake-up method according to an embodiment of this application;

FIG. 11 is an instance diagram of a scenario in which a GO wakes up a Wi-Fi direct link in a Wi-Fi link sleep and wake-up method according to an embodiment of this application;

FIG. 12 is a schematic flowchart of a method for waking up a Wi-Fi direct link by a GC in a Wi-Fi link sleep and wake-up method according to an embodiment of this application;

FIG. 13 is a schematic flowchart of a method for waking up a Wi-Fi direct link by a GC in a Wi-Fi link sleep and wake-up method according to an embodiment of this application;

FIG. 14 is an instance diagram of a scenario in which a GC wakes up a Wi-Fi direct link in a Wi-Fi link sleep and wake-up method according to an embodiment of this application;

FIG. 15 is a schematic flowchart of a method for waking up a Wi-Fi direct link by a GC in a Wi-Fi link sleep and wake-up method according to an embodiment of this application;

FIG. 16 is an instance diagram of a scenario in which a GC wakes up a Wi-Fi direct link in a Wi-Fi link sleep and wake-up method according to an embodiment of this application;

FIG. 17 is a schematic flowchart of a method for waking up a Wi-Fi direct link by a GC in a Wi-Fi link sleep and wake-up method according to an embodiment of this application;

FIG. 18 is an instance diagram of a scenario in which a GC wakes up a Wi-Fi direct link in a Wi-Fi link sleep and wake-up method according to an embodiment of this application;

FIG. 19 is a schematic flowchart of a method for waking up a Wi-Fi direct link by a GC in a Wi-Fi link sleep and wake-up method according to an embodiment of this application;

FIG. 20 is an instance diagram of a scenario in which a GC wakes up a Wi-Fi direct link in a Wi-Fi link sleep and wake-up method according to an embodiment of this application;

FIG. 21 is a schematic flowchart of a method for waking up a Wi-Fi direct link by a GC in a Wi-Fi link sleep and wake-up method according to an embodiment of this application;

FIG. 22 is an instance diagram of a scenario in which a GC wakes up a Wi-Fi direct link in a Wi-Fi link sleep and wake-up method according to an embodiment of this application;

FIG. 23 is an instance diagram of a scenario of a Wi-Fi link sleep and wake-up method;

FIG. 24A and FIG. 24B are instance diagrams of scenarios of a Wi-Fi link sleep and wake-up method according to an embodiment of this application; and

FIG. 25 is a schematic composition diagram of a structure of an electronic device according to an embodiment of this application.

### DESCRIPTION OF EMBODIMENTS

Terms used in the following embodiments are merely intended to describe specific embodiments, but not to limit this application. The terms “one”, “a”, “the”, “the foregoing”, “this”, and “the one” of singular forms used in this specification and the appended claims of this application are also intended to include forms such as “one or more”, unless otherwise specified in the context clearly. It needs to be further understood that in the following embodiments of this application, “at least one” and “one or more” mean one or at least two (including two). The term “and/or” is used to describe an association relationship between associated objects and represents that three relationships may exist. For example, A and/or B may represent the following cases: Only A exists, both A and B exist, and only B exists, where A and B each may be singular or plural. The character “/” generally indicates an “or” relationship between the associated objects.

Reference to “an embodiment”, “some embodiments”, or the like described in this specification indicates that one or more embodiments of this application include a specific feature, structure, or characteristic described with reference to the embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise especially emphasized in another manner. The terms “include”, “contain”, “have”, and their variants all mean “include but are not limited to”, unless otherwise especially emphasized in another manner. The term “connection” includes a direct connection and an indirect connection, unless otherwise stated.

The terms “first” and “second” mentioned below are merely intended for a purpose of description, and shall not be understood as an indication or implication of relative importance or implicit indication of a quantity of indicated technical features. Therefore, a feature defined with “first” or “second” may explicitly or implicitly include one or more features.

In embodiments of this application, the word “example”, “for example”, or the like is used to represent giving an example, an illustration, or a description. Any embodiment or design scheme described as “example” or “for example” in embodiments of this application should not be interpreted as being more preferred to or having more advantages than another embodiment or design scheme. Exactly, use of the word “example”, “for example”, or the like is intended to present a relative concept in a specific manner.

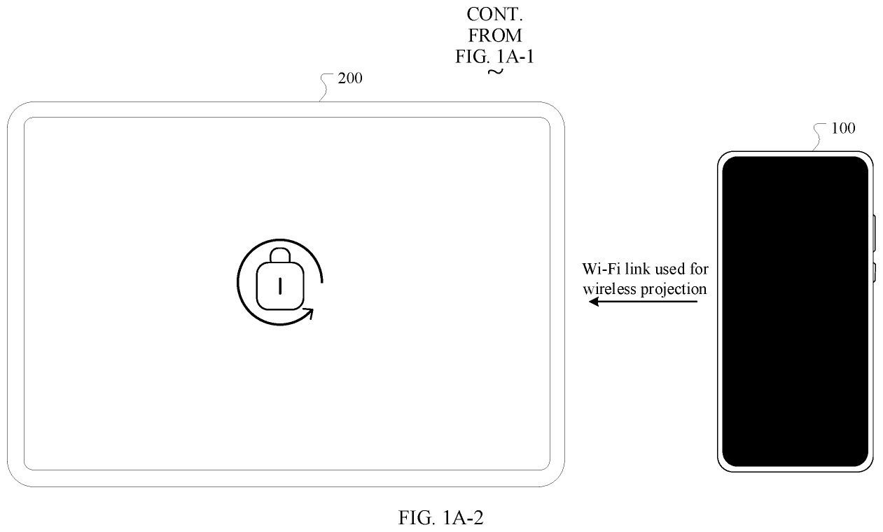

A Wi-Fi link sleep and wake-up method provided in an embodiment of this application may be applied to a system shown in FIG. 2. The system includes a source device 100 and a receiving device 200 that are used for wireless projection. The source device 100 and the receiving device 200 collaborate with each other and share a resource with each other. For example, an interface of the source device 100 is wirelessly projected to a display of the receiving device 200, and a user may, on the receiving device 200, operate the source device 100 and the receiving device 200. The source device 100 is connected to the receiving device 200 in a point-to-point (point-to-point, P2P) manner. For example, a Wi-Fi link used for wireless projection from the source device 100 to the receiving device 200 uses a Wi-Fi P2P protocol, namely, a Wi-Fi Direct (Direct) protocol. Wi-Fi Direct is a point-to-point connection technology. Two devices can directly establish a TCP/IP link without participation of an access point (access point, AP). One of the two devices in a point-to-point connection is used as an AP, and is called a group owner (group owner, GO). The other device is called a group client (group client, GC), and is connected to the GO, just like being connected to the AP. The GO and the GC may be in a one-to-one or one-to-multiple relationship. In some examples, the source device 100 is used as the GO, and the receiving device 200 is used as the GC. In some other examples, the source device 100 is used as the GC, and the receiving device 200 is used as the GO. This does not affect implementation effect of embodiments of this application and is not limited in embodiments of this application.

In a process in which the source device 100 performs wireless projection to the receiving device 200, in some scenarios, a screen of the source device 100 is locked and turned off. For example, a user presses a power button of the source device 100 or does not operate the source device 100 in a long time. In some other scenarios, a screen of the receiving device 200 is locked and turned off. For example, the user presses a power button of the receiving device 200 or does not operate the receiving device 200 in a long time. The screen of the source device 100 is turned off or the screen of the receiving device 200 is turned off, a wireless projection service is suspended, and the Wi-Fi link used for wireless projection enters a low-power state (that is, sleep). When the user operates the source device 100 or the receiving device 200 again (for example, presses the power button of the source device 100 or the receiving device 200), the screen of the source device 100 or the receiving device 200 is turned on, the Wi-Fi link used for wireless projection exits from the low-power state and enters a working state, and the wireless projection service is resumed. The Wi-Fi link in the low-power state does not perform data transmission of the wireless projection service, and therefore power consumption is low.

This embodiment of this application provides a Wi-Fi link sleep and wake-up method. When the screen of the source device 100 is turned off, the source device 100 notifies the receiving device 200 that the Wi-Fi link enters the low-power state. When the screen of the source device 100 is turned on, the source device 100 notifies the receiving device 200 that the Wi-Fi link exits from the low-power state. When the screen of the receiving device 200 is turned off, the receiving device 200 notifies the source device 100 that the Wi-Fi link enters the low-power state. When the screen of the receiving device 200 is turned on, the receiving device 200 notifies the source device 100 that the Wi-Fi link exits from the low-power state. In this way, the Wi-Fi link used for wireless projection can enter or exit from the low-power state with a low latency.

The source device 100 may include a portable computer (like a mobile phone), a hand-held computer, a tablet computer, a laptop computer, a netbook, a personal computer (personal computer, PC), a smart home device (like a smart television, a smart screen, a large screen, or a smart speaker), a personal digital assistant (personal digital assistant, PDA), a wearable device (like a smart wristwatch or a smart band), an augmented reality (augmented reality, AR)/virtual reality (virtual reality, VR) device, an on-board computer, and the like. This is not limited in embodiments of this application.

The receiving device 200 may include a mobile screen (like a tablet computer, a laptop computer, or a netbook), a personal computer (personal computer, PC), a portable computer (like a mobile phone), a hand-held computer, a smart home device (like a smart television, a smart screen, a large screen, or a smart speaker), a personal digital assistant (personal digital assistant, PDA), an on-board computer, and the like. This is not limited in embodiments of this application.

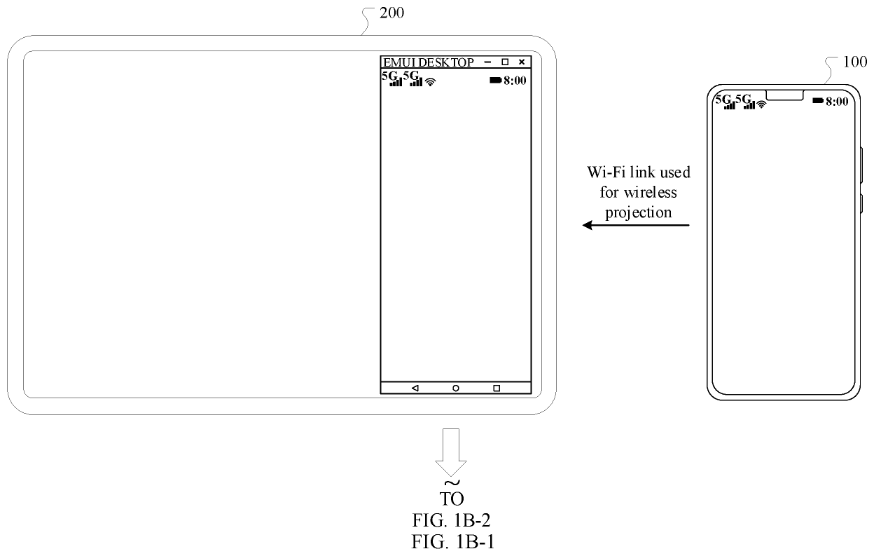

In an example, the source device 100 or the receiving device 200 may include a structure shown in FIG. 3. As shown in FIG. 3, an electronic device 300 may include a processor 110, an external memory interface 120, an internal memory 121, a universal serial bus (universal serial bus, USB) interface 130, a charging management module 140, a power management module 141, a battery 142, a display 150, an antenna, a wireless communication module 160, an audio module 170, a speaker 170A, a receiver 170B, a microphone 170C, a headset jack 170D, a sensor module 180, and the like.

It may be understood that the structure shown in this embodiment of this application does not constitute a specific limitation on the electronic device. In some other embodiments of this application, the electronic device may include more or fewer components than those shown in the figure, or combine some components, or split some components, or have a different component arrangement. The components shown in the figure may be implemented in hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a memory, a video codec, a digital signal processor (digital signal processor, DSP), a baseband processor, a neural-network processing unit (neural-network processing unit, NPU), and/or the like. Different processing units may be independent components, or may be integrated into one or more processors.

The controller may be a nerve center and a command center of the electronic device. The controller may generate an operation control signal based on instruction operation code and a time sequence signal, to complete control of instruction reading and instruction execution.

A memory may be further disposed in the processor 110, and is configured to store instructions and data. In some embodiments, the memory in the processor 110 is a cache memory. The memory may store instructions or data that has been used or cyclically used by the processor 110. If the processor 110 needs to use the instructions or the data again, the processor may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

The I2C interface is a bidirectional synchronous serial bus, and includes a serial data line (serial data line, SDA) and a serial clock line (serial clock line, SCL). In some embodiments, the processor 110 may include a plurality of groups of I2C buses. The processor 110 may be separately coupled to a touch sensor, a charger, a flash, a camera, and the like through different I2C bus interfaces. For example, the processor 110 may be coupled to the touch sensor through the I2C interface, so that the processor communicates with the touch sensor through the I2C bus interface, to implement a touch function of the electronic device.

The I2S interface may be configured to perform audio communication. In some embodiments, the processor 110 may include a plurality of groups of 2S buses. The processor 110 may be coupled to the audio module 170 through the I2S bus, to implement communication between the processor 110 and the audio module 170. In some embodiments, the audio module 170 may transmit an audio signal to the wireless communication module 160 through the I2S interface, to implement a function of answering a call through a Bluetooth headset.

The PCM interface may also be configured to perform audio communication, and sample, quantize, and encode an analog signal. In some embodiments, the audio module 170 may be coupled to the wireless communication module 160 through the PCM bus interface. In some embodiments, the audio module 170 may alternatively transmit an audio signal to the wireless communication module 160 through the PCM interface, to implement a function of answering a call through a Bluetooth headset. Both the I2S interface and the PCM interface may be configured to perform audio communication.

The UART interface is a universal serial data bus, and is configured to perform asynchronous communication. The bus may be a bidirectional communication bus. The bus converts to-be-transmitted data between serial communication and parallel communication. In some embodiments, the UART interface is usually configured to connect the processor 110 to the wireless communication module 160. For example, the processor 110 communicates with a Bluetooth module in the wireless communication module 160 through the UART interface, to implement a Bluetooth function. In some embodiments, the audio module 170 may transmit an audio signal to the wireless communication module 160 through the UART interface, to implement a function of playing music through a Bluetooth headset.

The MIPI interface may be configured to connect the processor 110 to a peripheral device like the display 150 and a keyboard. The MIPI interface includes a camera serial interface (camera serial interface, CSI), a display serial interface (display serial interface, DSI), and the like. In some embodiments, the processor 110 communicates with the display 150 through the DSI interface, to implement a display function of the electronic device.

The GPIO interface may be configured by using software. The GPIO interface may be configured as a control signal or as a data signal. In some embodiments, the GPIO interface may be configured to connect the processor 110 to the display 150, the wireless communication module 160, the audio module 170, the sensor 180, and the like. The GPIO interface may be further configured as an I2C interface, an I2S interface, a UART interface, a MIPI interface, or the like.

The USB interface 130 is an interface that conforms to USB standard specifications, and may be specifically a mini USB interface, a micro USB interface, a USB Type-C interface, or the like. The USB interface 130 may be configured to connect to a charger to charge the electronic device, or may be configured to perform data transmission between the electronic device and a peripheral device. For example, the electronic device is connected to a peripheral input device like a keyboard or a mouse through the interface, or may be configured to connect to a headset, and play audio through the headset. The interface may be further configured to connect to another electronic device like an AR device.

It may be understood that, an interface connection relationship between the modules shown in this embodiment of this application is only an example for description, and does not constitute a limitation on the structure of the electronic device. In some other embodiments of this application, the electronic device may alternatively use an interface connection different from that in the foregoing embodiment, or a combination of a plurality of interface connections.

The charging management module 140 is configured to receive a charging input from the charger. The charger may be a wireless charger or a wired charger. In some embodiments of wired charging, the charging management module 140 may receive a charging input of the wired charger through the USB interface 130. In some embodiments of wireless charging, the charging management module 140 may receive a wireless charging input through a wireless charging coil of the electronic device. The charging management module 140 may further supply power to the electronic device by using the power management module 141 while charging the battery 142.

The power management module 141 is configured to connect to the battery 142, the charging management module 140, and the processor 110. The power management module 141 receives an input of the battery 142 and/or the charging management module 140, and supplies power to the processor 110, the internal memory 121, an external memory, the display 150, the wireless communication module 160, and the like. The power management module 141 may be further configured to monitor parameters, such as a battery capacity, a quantity of battery cycles, and a battery health status (electric leakage or impedance). In some other embodiments, the power management module 141 may be alternatively provided in the processor 110. In some other embodiments, the power management module 141 and the charging management module 140 may be alternatively disposed in a same component.

The electronic device implements a display function by using the GPU, the display 150, the application processor, and the like. The GPU is a microprocessor for image processing, and is connected to the display 150 and the application processor. The GPU is configured to perform mathematical and geometric calculation, and render an image. The processor 110 may include one or more GPUs that execute program instructions to generate or change display information.

The display 150 is configured to display an image, a video, and the like. The display 150 includes a display panel. The display panel may be a liquid crystal display (liquid crystal display, LCD), an organic light-emitting diode (organic light-emitting diode, OLED), an active-matrix organic light-emitting diode (active-matrix organic light-emitting diode, AMOLED), a flexible light-emitting diode (flexible light-emitting diode, FLED), a mini-LED, a micro-LED, a micro-OLED, a quantum dot light-emitting diode (quantum dot light-emitting diode, QLED), or the like. In some embodiments, the electronic device may include one or N displays 150, where N is a positive integer greater than 1. In embodiments of this application, the display 150 is also referred to as a screen.

The digital signal processor is configured to process a digital signal, and may process another digital signal in addition to the digital image signal. For example, when the electronic device selects a frequency, the digital signal processor is configured to perform Fourier transformation and the like on frequency energy.

The video codec is configured to compress or decompress a digital video. The electronic device may support one or more types of video codecs. Therefore, the electronic device may play or record videos in a plurality of coding formats, for example, moving picture experts group (moving picture experts group, MPEG)-1, MPEG-2, MPEG-3, and MPEG-4.

The NPU is a neural-network (neural-network, NN) computing processor, quickly processes input information based on a structure of a biological neural network, for example, based on a transfer mode between human brain neurons; and may further continuously perform self-learning. The NPU can implement applications such as intelligent cognition of the electronic device, for example, image recognition, facial recognition, voice recognition, and text understanding.

The external memory interface 120 may be configured to connect to an external storage card, for example, a micro SD card, to extend a storage capability of the electronic device. The external memory card communicates with the processor 110 through the external memory interface 120, to implement a data storage function. For example, files such as music and videos are stored in the external storage card.

The internal memory 121 may be configured to store computer-executable program code. The executable program code includes instructions. The processor 110 runs the instructions stored in the internal memory 121, to perform various function applications of the electronic device and data processing. The internal memory 121 may include a program storage area and a data storage area. The program storage area may store an operating system, an application required by at least one function (for example, a sound playing function or an image playing function), and the like. The data storage area may store data (for example, audio data and a phone book) and the like created during use of the electronic device. In addition, the internal memory 121 may include a high-speed random access memory, and may further include a non-volatile memory, for example, at least one magnetic disk storage device, a flash memory device, or a universal flash storage (universal flash storage, UFS).

A wireless communication function of the electronic device may be implemented by using the antenna, the wireless communication module 160, the modem processor, and the like.

The antenna is configured to transmit and receive an electromagnetic wave signal. Each antenna of the electronic device may be configured to cover one or more communication frequency bands. Different antennas may be further multiplexed to improve antenna utilization. For example, the antenna may be multiplexed as a diversity antenna on a wireless local area network. In some other embodiments, the antenna may be used in combination with a tuning switch.

The wireless communication module 160 may provide a wireless communication solution that is applied to the electronic device and that includes a wireless local area network (wireless local area network, WLAN) (for example, a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, and an infrared (infrared, IR) technology. The wireless communication module 160 may be one or more components integrating at least one communication processing module. The wireless communication module 160 receives an electromagnetic wave through an antenna, performs frequency modulation and filtering processing on the electromagnetic wave signal, and sends a processed signal to the processor 110. The wireless communication module 160 may further receive a to-be-sent signal from the processor 110, perform frequency modulation and amplification on the to-be-sent signal, and convert the signal into an electromagnetic wave through an antenna and radiate the signal.

In some embodiments, the antenna of the electronic device is coupled to the wireless communication module 160, so that the electronic device may communicate with a network and another device by using a wireless communication technology. The wireless communication technology may include a global system for mobile communications (global system for mobile communications, GSM), a general packet radio service (general packet radio service, GPRS), code-division multiple access (code-division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GLONASS), a BeiDou navigation satellite system (BeiDou navigation satellite system, BDS), a quasi-zenith satellite system (quasi-zenith satellite system, QZSS), and/or a satellite based augmentation system (satellite based augmentation system, SBAS).

The electronic device may use the audio module 170, the speaker 170A, the receiver 170B, the microphone 170C, the headset jack 170D, the application processor, and the like to implement an audio function, for example, music playing and recording.

The audio module 170 is configured to convert digital audio information into an analog audio signal for output, and is also configured to convert an analog audio input into a digital audio signal. The audio module 170 may be configured to encode and decode an audio signal. In some embodiments, the audio module 170 may be disposed in the processor 110, or some functional modules of the audio module 170 are disposed in the processor 110.

The speaker 170A, also referred to as a “loudspeaker”, is configured to convert an audio electrical signal into a sound signal. The electronic device may use the speaker 170A to listen to music or answer a hands-free call.

The receiver 170B, also referred to as an “earpiece”, is configured to convert an audio electrical signal into a sound signal. When a call is answered or voice information is received through the electronic device, the receiver 170B may be put close to a human ear to receive a voice.

The microphone 170C, also referred to as a “mike” or a “mic”, is configured to convert a sound signal into an electrical signal. When making a call or sending voice information, a user may make a sound near the microphone 170C through the mouth of the user, to input a sound signal to the microphone 170C. At least one microphone 170C may be disposed in the electronic device. In some other embodiments, two microphones 170C may be disposed in the electronic device, to implement a noise reduction function in addition to collecting a sound signal. In some other embodiments, three, four, or more microphones 170C may alternatively be disposed in the electronic device, to collect a sound signal, reduce noise, identify a sound source, implement a directional recording function, and the like.

The headset jack 170D is configured to connect to a wired headset. The headset jack 170D may be a USB interface 130, or may be a 3.5 mm open mobile electronic device platform (open mobile terminal platform, OMTP) standard interface or a cellular telecommunications industry association of the USA (cellular telecommunications industry association of the USA, CTIA) standard interface.

The sensor module 180 may include a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, and the like.

The following describes in detail the Wi-Fi link sleep and wake-up method provided in embodiments of this application by using an example in which a mobile phone is used as a GO, a mobile screen is used as a GC, and wireless projection is performed from the mobile phone to the mobile screen.

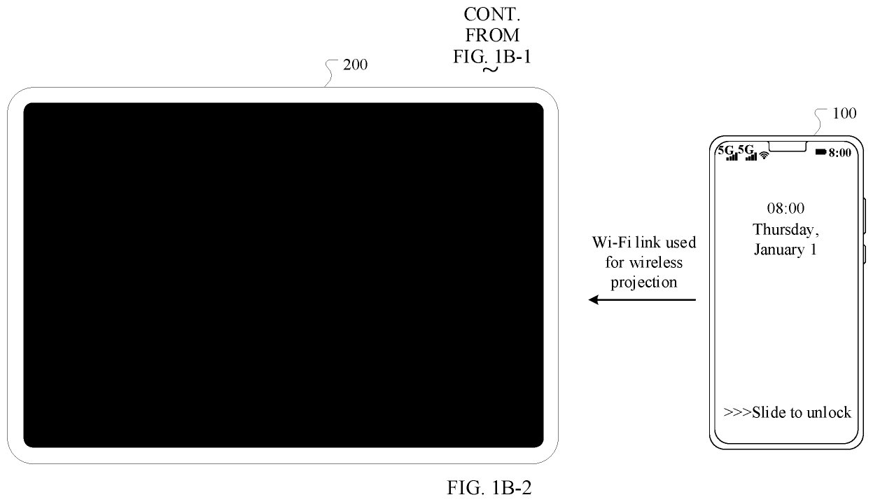

As shown in FIG. 4, wireless projection is performed from a mobile phone to a mobile screen. Transmission of wireless projection data is performed between the mobile phone and the mobile screen through a Wi-Fi direct (Direct) link. When a first preset condition is met, the wireless projection service is suspended, and the mobile phone (GO) enables the Wi-Fi direct link to enter the low-power state (that is, sleep). The first preset condition includes: A screen of the mobile phone is turned off. For example, if a user presses a power button of the mobile phone when the screen of the mobile phone is on, the screen of the mobile phone is turned off. For another example, when the user does not operate the mobile phone in a long time, the screen of the mobile phone is locked and turned off. When a second preset condition is met, the mobile phone (GO) wakes up the Wi-Fi direct link, the Wi-Fi direct link exits from the low-power state, and the wireless projection service is resumed. The second preset condition includes: The screen of the mobile phone is turned on. For example, when the user picks up the mobile phone, the screen of the mobile phone is turned on. For another example, if the user presses the power button of the mobile phone when the screen of the mobile phone is off, the screen of the mobile phone is turned on.

Wireless projection is performed from the mobile phone to the mobile screen. Transmission of wireless projection data is performed between the mobile phone and the mobile screen through the Wi-Fi direct (Direct) link. When a third preset condition is met, the wireless projection service is suspended, and the mobile screen (GC) enables the Wi-Fi direct link to enter the low-power state (that is, sleep). The third preset condition includes: The mobile screen is turned off. For example, if the user presses a power button of the mobile screen when the mobile screen is on, the mobile screen is turned off. For another example, when the user does not operate the mobile screen in a long time, the mobile screen is locked and turned off. When a fourth preset condition is met, the mobile screen (GC) wakes up the Wi-Fi direct link, the Wi-Fi direct link exits from the low-power state, and the wireless projection service is resumed. The fourth preset condition includes: The mobile screen is turned on. For example, when the user picks up the mobile screen, the mobile screen is turned on. For another example, if the user presses the power button of the mobile screen when the mobile screen is off, the mobile screen is turned on.

According to the Wi-Fi link sleep and wake-up method provided in this embodiment of this application, when the first preset condition is met, the GO enables Wi-Fi direct link sleep. When the second preset condition is met, the GO wakes up the Wi-Fi direct link. When the third preset condition is met, the GC enables Wi-Fi direct link sleep. When the fourth preset condition is met, the GC wakes up the Wi-Fi direct link. Both the mobile phone and the mobile screen may enable Wi-Fi direct link sleep, and both the mobile phone and the mobile screen may wake up the Wi-Fi direct link. The following separately provides detailed descriptions with reference to the accompanying drawings.

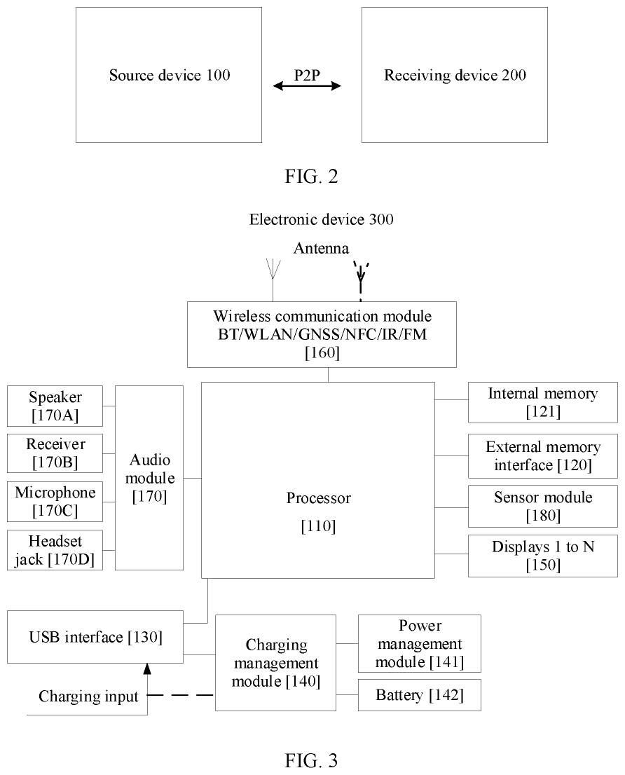

FIG. 5 is a schematic flowchart of a method for enabling, by a GO, Wi-Fi direct link sleep. As shown in FIG. 5, the method includes the following steps.

S101: The GO sends a first message to a GC.

The GO sends the first message to the GC. The first message is used to notify the GC to enable Wi-Fi direct link sleep. In an implementation, after the GO sends the first message, the GO enters a low-power state of a Wi-Fi direct link.

S102: The Wi-Fi direct link enters the low-power state.

The GC receives the first message and enters the low-power state of the Wi-Fi direct link. The Wi-Fi link in the low-power state does not perform data transmission of a wireless projection service. In an example, the low-power state of the Wi-Fi link includes a sleep window and a non-sleep window (namely, a working window). In the sleep window, the GO and the GC do not perform data transmission, and therefore power consumption is low. In the working window, the GO and the GC may perform signaling data transmission, and therefore power consumption is relatively high. It may be understood that, a longer sleep window indicates lower power consumption of the Wi-Fi link in the low-power state.

In some examples, the GO enables, by using a sleep notification mechanism (notice of absence, NOA), Wi-Fi direct link sleep. The GO periodically sends beacon (beacon) frames to the GC, and the GC listens to the beacon frames. In an embodiment of this application, an interval at which the GO sends the beacon frames is referred to as a beacon frame interval. For example, the GO sends one beacon frame to the GC every 100 ms, and then the beacon frame interval is 100 ms.

Optionally, the beacon frame includes a sleep interval count (count), where the sleep interval count indicates a quantity of times the sleep window is entered. If the GO determines to make the Wi-Fi direct link enter the low-power state, the sleep interval count is set to be greater than 0 (a beacon frame in which the sleep interval count is greater than 0 is the first message) in the sent beacon frame. If the sleep interval count is greater than 0, it indicates that the Wi-Fi direct link enters the low-power state. Optionally, the beacon frame further includes information, such as a sleep start time (start time), an absent period (absent period), and a sleep interval (interval). The sleep start time indicates a start moment at which the sleep window is entered for a first time. The absent period indicates duration in which the sleep window remains each time. The sleep interval indicates a time interval at which the sleep window is entered. The Wi-Fi direct link does not perform data transmission in the sleep window, and therefore power consumption is relatively low. The Wi-Fi direct link may perform signaling data transmission in the non-sleep window (the working window) of the low-power state, and therefore power consumption is relatively high.

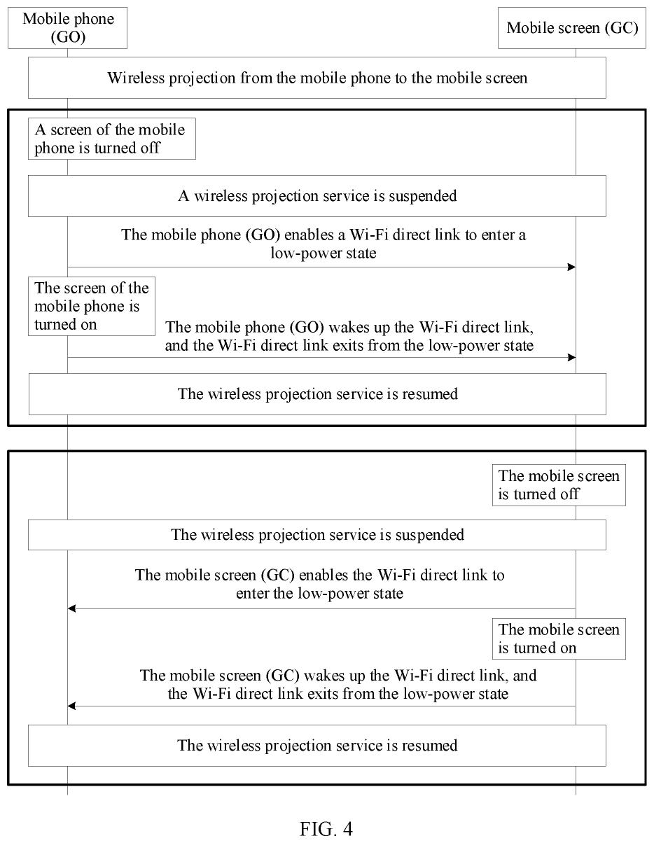

In an example, as shown in FIG. 6A, the GO periodically sends beacon frames to the GC. The sleep interval count in a first beacon frame is 2, indicating that the quantity of times the sleep window is entered is 2. The sleep interval count in a second beacon frame is 3, indicating that the quantity of times the sleep window is entered is 3. The sleep interval count in a third beacon frame is 1, indicating that the quantity of times the sleep window is entered is 1.

In each beacon frame interval, the GO switches between the sleep window and the working window based on parameters, such as the sleep interval count (count), the sleep start time (start time), the absent period (absent period), and the sleep interval (interval), in the beacon frame interval. The GC receives the beacon frame, determines that the sleep interval count in the beacon frame is greater than 0, and determines that the Wi-Fi direct link in the beacon frame interval is in the low-power state. In the beacon frame interval, the GC switches between the sleep window and the working window based on the parameters, such as the sleep interval count (count), the sleep start time (start time), the absent period (absent period), and the sleep interval (interval), in the beacon frame.

In another example, a parameter indicated by the GO in a beacon frame may be applied to a plurality of beacon frame intervals. As shown in FIG. 6B, the GO periodically sends beacon frames to the GC. The sleep interval count in a first beacon frame is 6, indicating that the quantity of times the sleep window is entered is 6. A second beacon frame does not include the sleep interval count. The sleep interval count in a third beacon frame is 1, indicating that the quantity of times the sleep window is entered is 1. The first beacon frame further includes information, such as the sleep start time (start time), the absent period (absent period), and the sleep interval (interval). The third beacon frame further includes information, such as the sleep start time (start time), the absent period (absent period), and the sleep interval (interval).

After sending the first beacon frame, the GO switches between the sleep window and the working window based on parameters, such as the sleep interval count (count), the sleep start time (start time), the absent period (absent period), and the sleep interval (interval), in the first beacon frame. The GC receives the first beacon frame, determines that the sleep interval count in the beacon frame is greater than 0, and determines that the Wi-Fi direct link enters the low-power state. The GC switches between the sleep window and the working window based on the parameters, such as the sleep interval count (count), the sleep start time (start time), the absent period (absent period), and the sleep interval (interval), in the first beacon frame. It may be understood that, based on the parameters in the first beacon frame, the GO and the GC enter the sleep window for six times, and a total absent period is greater than one beacon frame interval. The second beacon frame sent by the GO to the GC does not include a parameter, like the sleep interval count. After sending the third beacon frame, the GO switches between the sleep window and the working window based on parameters, such as the sleep interval count (count), the sleep start time (start time), the absent period (absent period), and the sleep interval (interval), in the third beacon frame. The GC receives the third beacon frame, determines that the sleep interval count in the beacon frame is greater than 0, and determines that the Wi-Fi direct link is in the low-power state. The GC switches between the sleep window and the working window based on the parameters, such as the sleep interval count (count), the sleep start time (start time), the absent period (absent period), and the sleep interval (interval), in the third beacon frame.

In another example, one sleep window may span a plurality of beacon frame intervals. For example, as shown in FIG. 6C, the GO periodically sends beacon frames to the GC. The sleep interval count in a first beacon frame is 2, indicating that the quantity of times the sleep window is entered is 2. After sending the first beacon frame, the GO switches between the sleep window and the working window based on parameters, such as the sleep interval count (count), the sleep start time (start time), the absent period (absent period), and the sleep interval (interval), in the first beacon frame. The GC receives the first beacon frame, determines that the sleep interval count in the beacon frame is greater than 0, and determines that the Wi-Fi direct link enters the low-power state. The GC switches between the sleep window and the working window based on the parameters, such as the sleep interval count (count), the sleep start time (start time), the absent period (absent period), and the sleep interval (interval), in the first beacon frame. One sleep window spans two beacon frame intervals. A second beacon frame and a third beacon frame sent by the GO to the GC do not include a parameter, like the sleep interval count. It may be understood that, in the sleep window, the GO may send a beacon frame, and the GC may listen to the beacon frame.

It may be understood that, in some implementations, the absent period is set to a relatively large value, and power consumption of the Wi-Fi direct link is relatively low, but a packet may be sent only in the non-sleep window or after exit of the low-power state, which affects a service latency. In some other implementations, the absent period is set to a relatively small value, power consumption of the Wi-Fi direct link is relatively high, but the service latency is relatively low. A value of a parameter like the absent period may be adjusted based on an actual situation.

In this method, the GO enables Wi-Fi direct link sleep. For example, a mobile phone is used as the GO, and a mobile screen is used as the GC. If a screen of the mobile phone is turned off, the mobile phone enables Wi-Fi direct link sleep.

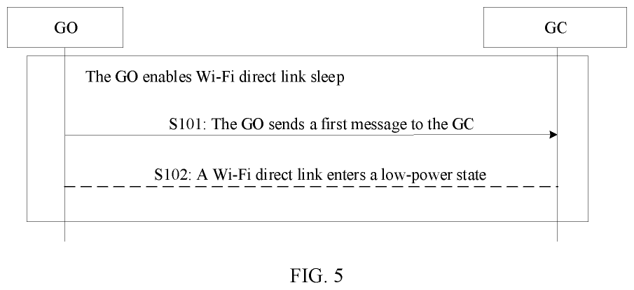

FIG. 7 is a schematic flowchart of a method for enabling, by a GC, Wi-Fi direct link sleep. As shown in FIG. 7, the method includes the following steps.

S201: The GC sends a first request message to a GO.

The GC sends the first request message to the GO. The first request message is used to trigger the GO to enable Wi-Fi direct link sleep.

In an implementation, the first request message is a link layer message. For example, the GC sends a first management (action) frame to the GO. The first action frame is used to trigger the GO to enable Wi-Fi direct link sleep. For example, the first management (action) frame is a custom action frame in the 802.11 protocol.

In an implementation, the first request message is a service layer message. For example, the first request message is a projection suspension request message, and is sent through a transfer control protocol (transfer control protocol, TCP) or a user datagram protocol (user datagram protocol, UDP) service channel. The projection suspension request message is used to request to suspend transmission of wireless projection data.

S202: The GO sends a first message to the GC.

The GO receives the first request message, and sends the first message to the GC in a next beacon frame interval. The first message is used to notify the GC to enable Wi-Fi direct link sleep. After the GO sends the first message, the GO enters a low-power state of a Wi-Fi direct link.

S203: The Wi-Fi direct link enters the low-power state.

The GC receives the first message and enters the low-power state of the Wi-Fi direct link.

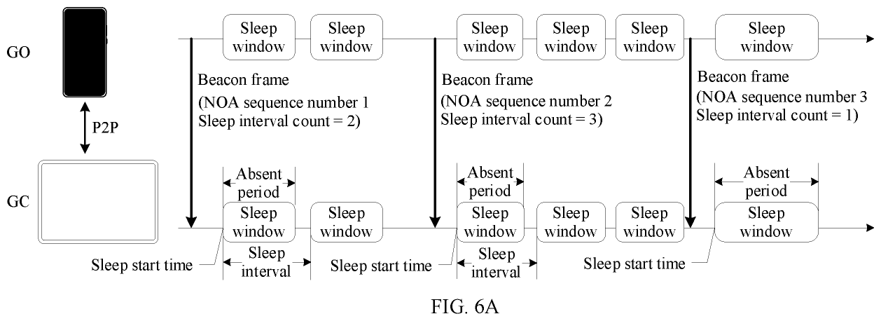

In an example, as shown in FIG. 8, the GC determines to suspend a wireless projection service, and determines whether to enter the low-power state of the Wi-Fi direct link. For example, if a screen of the GC is turned off, it is determined to enter the low-power state of the Wi-Fi direct link. For another example, if an operation of pressing a power button by a user is received in a screen-on state, it is determined to enter the low-power state of the Wi-Fi direct link. If it is determined to enter the low-power state of the Wi-Fi direct link, the GC sends the first request message to the GO. The GO receives the first request message, and determines to enter the low-power state of the Wi-Fi direct link in a next beacon frame. At a time point of sending the next beacon frame, the GO sends the first message to the GC. For example, the first message is a beacon frame, and a sleep interval count in the beacon frame is greater than 0. The beacon frame further includes information, such as a sleep start time (start time), an absent period (absent period), and a sleep interval (interval). The GO and the GC switch between a sleep window and a working window based on parameters, such as the sleep interval count (count), the sleep start time (start time), the absent period (absent period), and the sleep interval (interval), in the beacon frame.

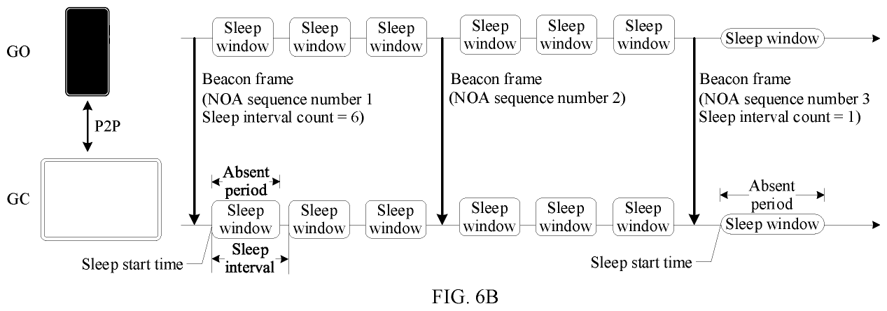

In some examples, by sending the link layer message to the GO, the GC triggers the GO to enable Wi-Fi direct link sleep. For example, as shown in FIG. 9, if the GC determines to enter the low-power state of the Wi-Fi direct link, the GC sends a first management frame to the GO. The GO receives the first management frame, and includes information, such as the sleep interval count, the sleep start time (start time), the absent period (absent period), and the sleep interval (interval), in the next beacon frame, where the sleep interval count is greater than 0. The GC receives the beacon frame, determines that the sleep interval count in the beacon frame is greater than 0, and determines that the Wi-Fi direct link enters the low-power state. The GO and the GC switch between the sleep window and the working window based on parameters, such as the sleep interval count (count), the sleep start time (start time), the absent period (absent period), and the sleep interval (interval), in the beacon frame.

In this method, the GC enables Wi-Fi direct link sleep. For example, a mobile phone is used as the GO, and a mobile screen is used as the GC. If the mobile screen is turned off, the mobile screen enables Wi-Fi direct link sleep.

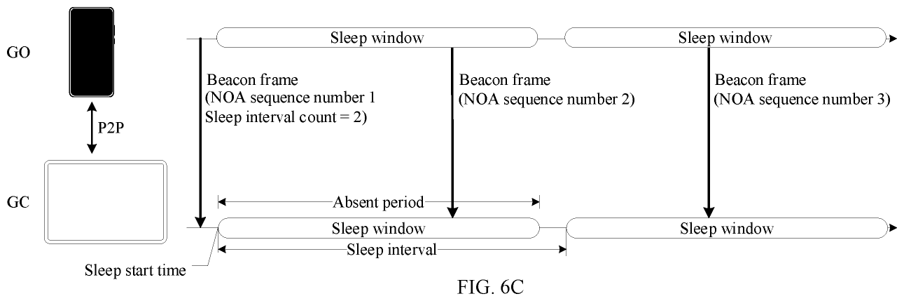

FIG. 10 is a schematic flowchart of a method for waking up a Wi-Fi direct link by a GO. As shown in FIG. 10, the method includes the following steps.

S301: The GO sends a second message to a GC.

The GO sends the second message to the GC, and the GO exits from a low-power state of a Wi-Fi direct link. The second message is used to notify the GC to exit from the low-power state of the Wi-Fi direct link.

S302: The Wi-Fi direct link exits from the low-power state.

The GC receives the second message and exits from the low-power state of the Wi-Fi direct link. When the Wi-Fi direct link exits from the low-power state, a wireless projection service may be resumed for data transmission.

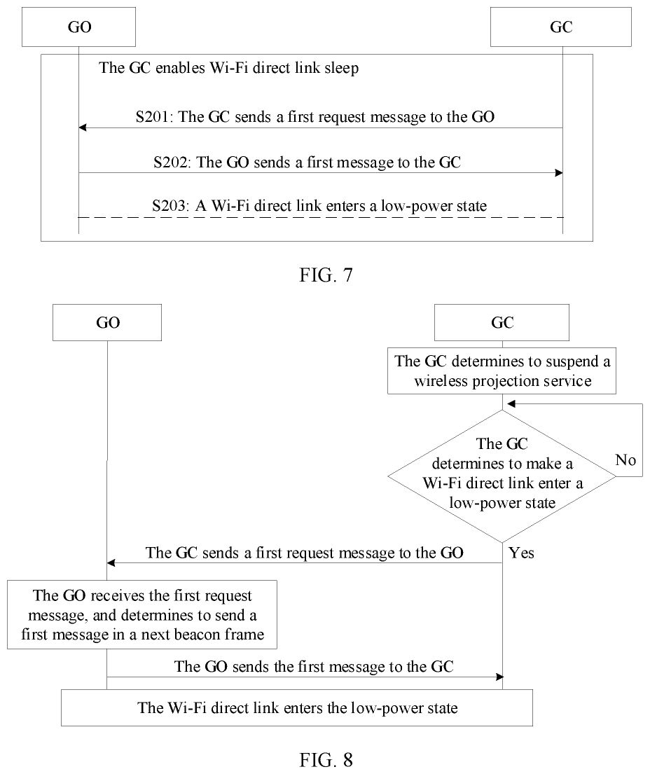

In some examples, the GO wakes up the Wi-Fi direct link by using an NOA. For example, as shown in FIG. 11, the GO periodically sends beacon (beacon) frames to the GC. The beacon frame includes a sleep interval count (count). If the sleep interval count in a beacon frame with an NOA sequence number 1 is greater than 0, the Wi-Fi direct link enters the low-power state based on a parameter in the beacon frame. For example, in the beacon frame interval, if a mobile phone (GO) receives an operation of pressing a power button by a user, the GO determines to wake up the Wi-Fi direct link. The GO notifies, in a next beacon frame (a beacon frame with an NOA sequence number 2), that the GC exits from the low-power state of the Wi-Fi direct link. The sleep interval count in the beacon frame with the NOA sequence number 2 is equal to 0, indicating that the Wi-Fi direct link exits from the low-power state. In this way, after sending the beacon frame with the NOA sequence number 2, the GO exits from the low-power state of the Wi-Fi direct link. The GC receives the beacon frame with the NOA sequence number 2, and exits from the low-power state of the Wi-Fi direct link.

In this method, the GO wakes up the Wi-Fi direct link. For example, a mobile phone is used as the GO, and a mobile screen is used as the GC. If a screen of the mobile phone is turned on, the mobile phone wakes up the Wi-Fi direct link.

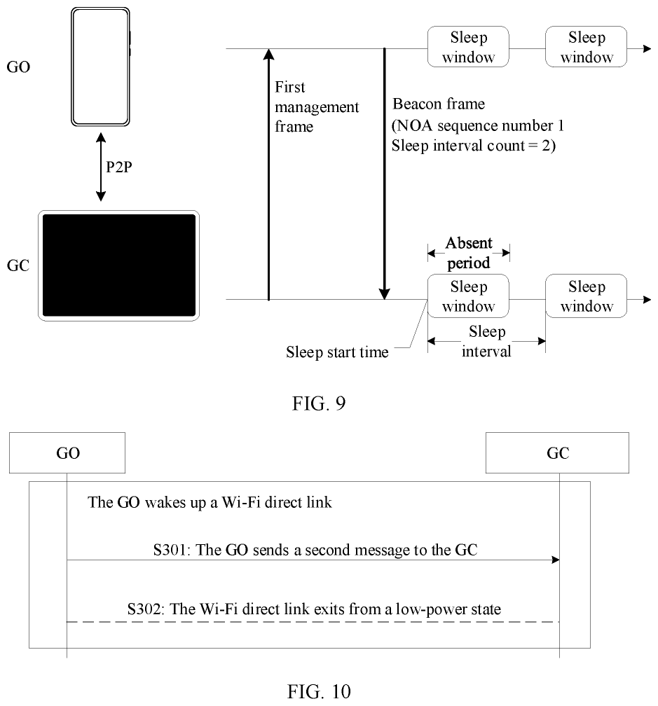

FIG. 12 is a schematic flowchart of a method for waking up a Wi-Fi direct link by a GC. As shown in FIG. 12, the method includes the following steps.

S401: The GC sends a second request message to a GO.

The GC sends the second request message (a wake-up request message) to the GO. The second request message is used to trigger the GO to wake up a Wi-Fi direct link.

The Wi-Fi direct link is in a low-power state, and the GO and the GC do not perform data transmission in a sleep window of the low-power state. In some embodiments, the GO establishes a Bluetooth low energy (Bluetooth low energy, BLE) connection with the GC, and the GC sends the second request message to the GO by using a BLE connection message. In some other embodiments, the GC sends the second request message to the GO by using a BLE directed broadcast message. In some other embodiments, the GC sends the second request message to the GO in a non-sleep window of the low-power state. For example, the second request message is a link layer message or a service layer message.

S402: The GO sends a second message to the GC.

The GO receives the second request message, and sends the second message (a wake-up message) to the GC in a next beacon frame, and the GO exits from the low-power state of the Wi-Fi direct link. The second message is used to notify the GC to exit from the low-power state of the Wi-Fi direct link.

S403: The Wi-Fi direct link exits from the low-power state.

The GC receives the second message and exits from the low-power state of the Wi-Fi direct link. When the Wi-Fi direct link exits from the low-power state, a wireless projection service may be resumed for data transmission.

In this method, the GC triggers wake-up of the Wi-Fi direct link. For example, a mobile phone is used as the GO, and a mobile screen is used as the GC. If the mobile screen is turned on, the mobile screen triggers wake-up of the Wi-Fi direct link.

In some embodiments, a GC sends a second request message to a GO by using a BLE connection message.

After two devices that support BLE communication discover each other through Bluetooth, a BLE connection is established. After the BLE connection is successfully established, BLE communication is in a master/slave mode. For the two devices that have established the BLE connection with each other, one is a master device (master), and the other is a slave device (slave). Usually, a BLE connection initiator is called the master device, and a connected device is called the slave device. After the master device sends a Bluetooth data packet to the slave device, the slave device returns Bluetooth data to the master device within a specified time. The slave device cannot initiatively send the Bluetooth data to the master device.

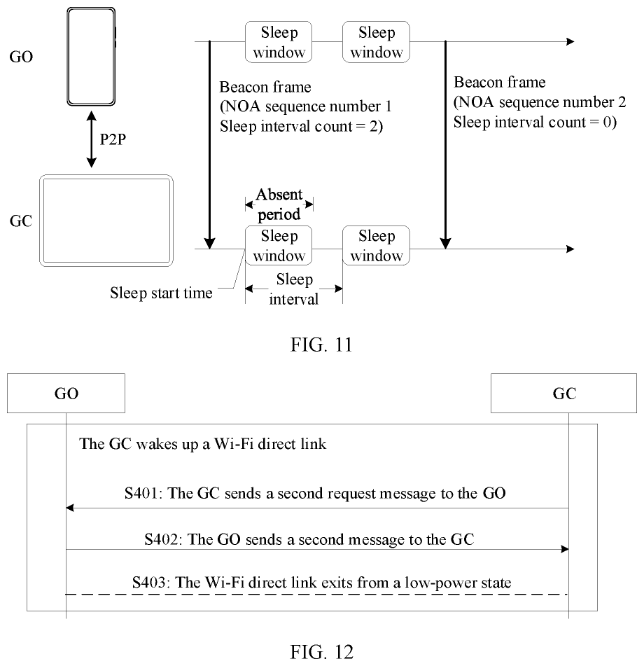

In an example, the GC is a BLE master device, and the GO is a BLE slave device. As shown in FIG. 13, the GO sends a first BLE broadcast. The first BLE broadcast is used by another device to discover the GO. The GC detects the first BLE broadcast from the GO, that is, discovers the GO. The GC sends a BLE connection request to the GO. The BLE connection request is used to request to establish a BLE connection. After receiving the BLE connection request, the GO sends a BLE connection response to the GC. The BLE connection response is used to acknowledge the establishment of the BLE connection. The GC receives the BLE connection response and the BLE connection is successfully established. During the BLE connection establishment, the GC initiates the BLE connection request, and the GC is the BLE master device. The GC periodically sends first BLE request messages to the GO based on first duration. For example, the first BLE request message is used to keep a BLE connection alive between the GC and the GO. For another example, the first BLE request message is used by the GC to send Bluetooth data to the GO. Each time the GO receives the first BLE request message, the GO returns a first BLE response message to the GC. For example, the first BLE response message is used by the GO to send Bluetooth data to the GC. For another example, the first BLE response message is an empty message. If a Wi-Fi direct link is in a low-power state, the GC determines to resume a wireless projection service, and the GC determines whether to exit from the low-power state of the Wi-Fi direct link. For example, if a screen of the GC is turned on, it is determined to exit from the low-power state of the Wi-Fi direct link. For another example, if an operation of pressing a power button by a user is received in a screen-off state, it is determined to exit from the low-power state of the Wi-Fi direct link. If it is determined to exit from the low-power state of the Wi-Fi direct link, the GC includes first indication information in a next first BLE request message that is sent by the GC to the GO. The first indication information is used to trigger the GO to wake up a Wi-Fi direct link (to enable the Wi-Fi direct link to exit from the low-power state). The GO receives the first indication information, and determines to send a second message in a next beacon frame interval. At a time point of sending a next beacon frame, the GO sends the second message to the GC. For example, the second message is a beacon frame, and a sleep interval count in the beacon frame is equal to 0. The GC receives the second message. The GO and the GC exit from the low-power state of the Wi-Fi direct link. When the Wi-Fi direct link exits from the low-power state, the wireless projection service may be resumed for data transmission.

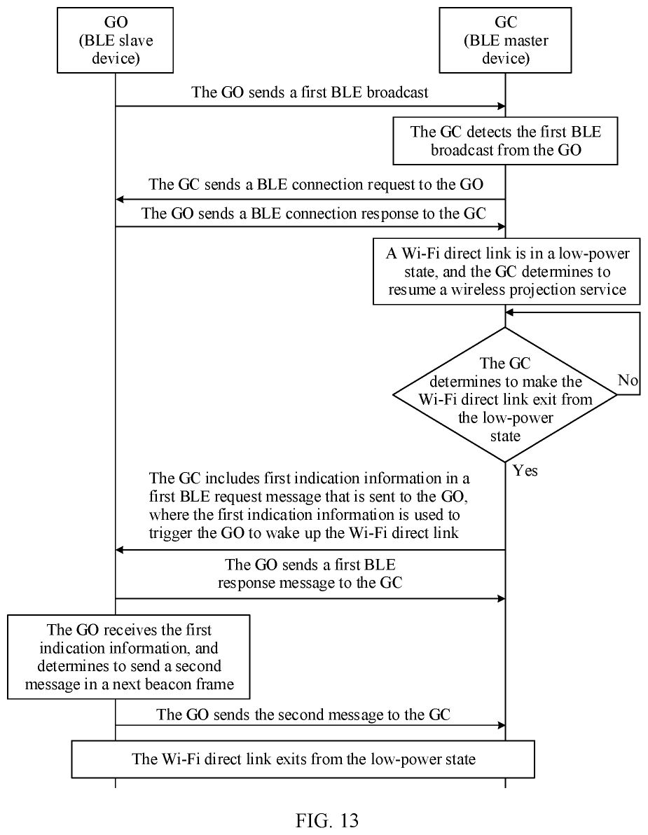

For example, as shown in FIG. 14, the GO sends the first BLE broadcast. The GC detects the first BLE broadcast from the GO, and discovers the GO. The GC sends, to the GO, a BLE generic attribute profile (generic attribute profile, GATT) persistent connection request, which is used to request to establish a BLE GATT persistent connection. For example, the BLE GATT persistent connection request is a master send request. The GO replies, to the GC, with a BLE GATT persistent connection response, which is used to acknowledge the establishment of the BLE GATT persistent connection. For example, the BLE GATT persistent connection response is a slave send response. The GC receives the BLE GATT persistent connection response and the BLE GATT persistent connection is successfully established. The GC, as the BLE master device, periodically sends first BLE request messages to the GO. Each time the GO receives the first BLE request message, the GO returns a first BLE response message to the GC.

If the sleep interval count in a beacon frame with an NOA sequence number 1 sent by the GO to the GC is greater than 0, the Wi-Fi direct link enters the low-power state. For example, in the beacon frame interval, if a mobile screen (GC) receives an operation of pressing a power button by a user, the GC determines to wake up the Wi-Fi direct link. The GC includes first indication information in a next first BLE request message for determining to wake up the Wi-Fi direct link. The first indication information is used to trigger the GO to wake up the Wi-Fi direct link. After the GO receives the first indication information, the sleep interval count in a next beacon frame (with an NOA sequence number 2) is equal to 0. In this way, after sending the beacon frame with the NOA sequence number 2, the GO exits from the low-power state of the Wi-Fi direct link. The GC receives the beacon frame with the NOA sequence number 2, and exits from the low-power state of the Wi-Fi direct link.

In this method, the GC establishes the BLE connection with the GO, the GC is the BLE master device, and the GO is the BLE slave device. The GC triggers the GO to wake up the Wi-Fi direct link by using the first indication information carried in the first BLE request message (a second request message). In a sleep window of the Wi-Fi direct link, the second request message may also be successfully sent and received. In this way, the GC may also initiatively trigger wake-up of the Wi-Fi direct link, instead of waiting for the GO to wake up the Wi-Fi direct link. This reduces a latency in waking up the Wi-Fi direct link, and the wireless projection service may be resumed with a low latency.

Further, it may be understood that, in the sleep window, the GC and the GO do not perform data transmission, and therefore power consumption is relatively low. The sleep window may be set to relatively long duration, so that power consumption may be reduced. However, in this method, sending of the first BLE request message is not limited by the sleep window, and even if the sleep window is set to relatively long duration, wake-up of the Wi-Fi direct link with a low latency is not affected. In this way, power consumption can be reduced as much as possible, and wake-up of the Wi-Fi direct link with the low latency can be ensured.

It needs to be noted that the sleep window duration in FIG. 14 is less than a beacon frame sending interval. In some other embodiments, sleep window duration may also be set to be greater than a beacon frame sending interval. For example, the sleep window duration is 5s, and the beacon frame sending interval is 10 ms. In this way, power consumption of a Wi-Fi direct link in a low-power state is lower. It may be understood that, in a sleep window, a GO and a GC do not perform data transmission, but may send and receive a beacon frame, which does not affect that the GO sends a beacon frame to wake up the Wi-Fi direct link.

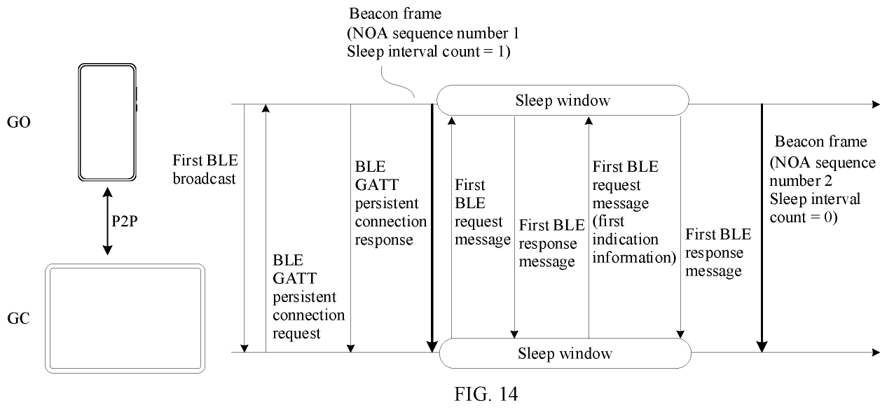

In another implementation, as shown in FIG. 15, after the GC establishes a BLE connection with the GO, if the Wi-Fi direct link is in the low-power state, the GC determines to exit from the low-power state of the Wi-Fi direct link and the GC sends a first BLE indication message to the GO. The first BLE indication message is used to trigger the GO to wake up the Wi-Fi direct link. The GO receives the first BLE indication message, and determines to send a second message in a next beacon (beacon) frame. At a time point of sending a next beacon frame, the GO sends the second message to the GC, and exits from the low-power state of the Wi-Fi direct link. The GC receives the second message and exits from the low-power state of the Wi-Fi direct link. When the Wi-Fi direct link exits from the low-power state, a wireless projection service may be resumed for data transmission.

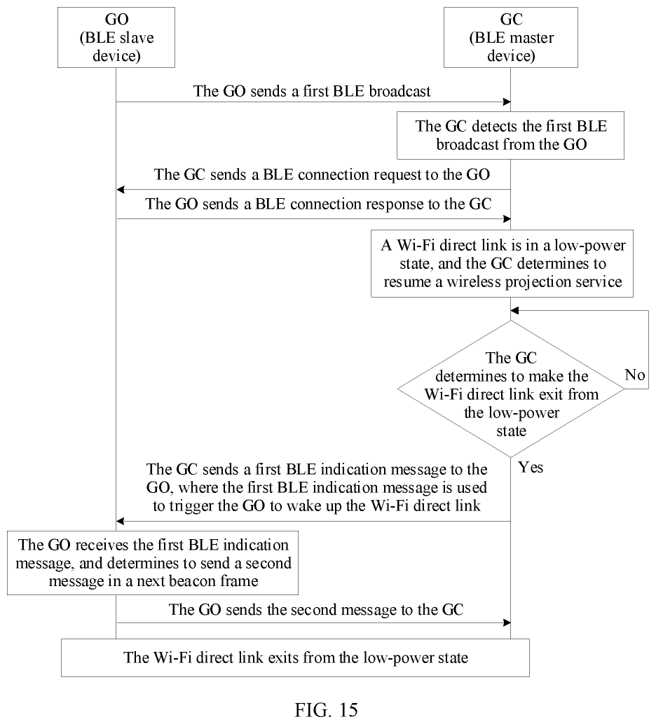

For example, as shown in FIG. 16, the GO sends a first BLE broadcast. The GC detects the first BLE broadcast from the GO, and discovers the GO. The GC sends a BLE GATT persistent connection request to the GO, the GO replies with a BLE GATT persistent connection response to the GC, and a BLE GATT persistent connection is successfully established. If a sleep interval count in a beacon frame with an NOA sequence number 1 sent by the GO to the GC is greater than 0, the Wi-Fi direct link enters the low-power state. For example, in the beacon frame interval, if a mobile screen (GC) receives an operation of pressing a power button by a user, the GC determines to wake up the Wi-Fi direct link. The GC sends, to the GO, a first BLE indication message, which is used to trigger the GO to wake up the Wi-Fi direct link. After the GO receives the first BLE indication message, the sleep interval count in a next beacon frame (with an NOA sequence number 2) is equal to 0. In this way, after sending the beacon frame with the NOA sequence number 2, the GO exits from the low-power state of the Wi-Fi direct link. The GC receives the beacon frame with the NOA sequence number 2, and exits from the low-power state of the Wi-Fi direct link.

In this implementation, the GC establishes the BLE connection with the GO, the GC is a BLE master device, and the GO is a BLE slave device. The GC sends the first BLE indication message (a second request message) to trigger the GO to wake up the Wi-Fi direct link. In a sleep window of the Wi-Fi direct link, the second request message may also be successfully sent and received. In this way, the GC may also initiatively trigger wake-up of the Wi-Fi direct link, instead of waiting for the GO to wake up the Wi-Fi direct link. This reduces a latency in waking up the Wi-Fi direct link, and the wireless projection service may be resumed with a low latency. In addition, the sleep window may be set to relatively long duration, which not only ensures power consumption reduction, but also does not affect wake-up of the Wi-Fi direct link with the low latency.

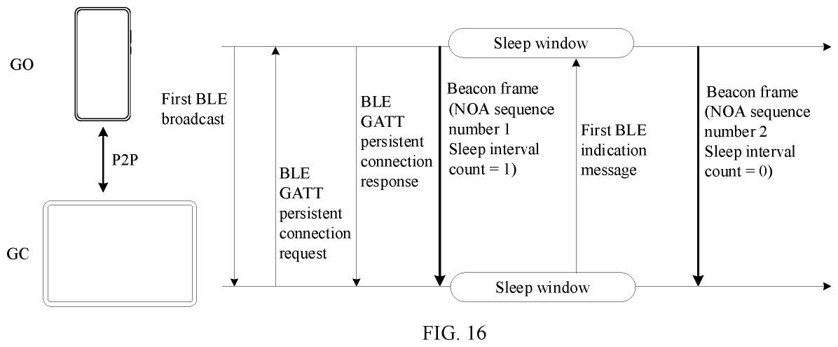

In another example, the GO is the BLE master device, and the GC is the BLE slave device. As shown in FIG. 17, the GC sends the first BLE broadcast. The first BLE broadcast is used by another device to discover the GC. The GO detects the first BLE broadcast from the GC, that is, discovers the GC. The GO sends a BLE connection request to the GC. The BLE connection request is used to request to establish a BLE connection. After receiving the BLE connection request, the GC sends a BLE connection response to the GO. The BLE connection response is used to acknowledge the establishment of the BLE connection. The GO receives the BLE connection response and the BLE connection is successfully established. During the BLE connection establishment, the GO initiates the BLE connection request, and the GO is the BLE master device. The GO periodically sends first BLE request messages to the GC based on first duration. For example, the first BLE request message is used to keep a BLE connection alive between the GO and the GC. For another example, the first BLE request message is used by the GO to send Bluetooth data to the GC. Each time the GC receives the first BLE request message, the GC returns a first BLE response message to the GO. For example, the first BLE response message is used by the GC to send Bluetooth data to the GO. For another example, the first BLE response message is an empty message. If the Wi-Fi direct link is in the low-power state, the GC determines to resume the wireless projection service, and the GC determines whether to exit from the low-power state of the Wi-Fi direct link. For example, if a screen of the GC is turned on, it is determined to exit from the low-power state of the Wi-Fi direct link. For another example, if an operation of pressing a power button by a user is received in a screen-off state, it is determined to exit from the low-power state of the Wi-Fi direct link. If it is determined to exit from the low-power state of the Wi-Fi direct link, the GC includes first indication information in a next first BLE response message that is sent to the GO. The first indication information is used to trigger the GO to wake up the Wi-Fi direct link (to enable the Wi-Fi direct link to exit from the low-power state). The GO receives the first indication information, and determines to send the second message in a next beacon (beacon) frame. At a time point of sending a next beacon frame, the GO sends the second message to the GC, and exits from the low-power state of the Wi-Fi direct link. The GC receives the second message and exits from the low-power state of the Wi-Fi direct link. When the Wi-Fi direct link exits from the low-power state, the wireless projection service may be resumed for data transmission.

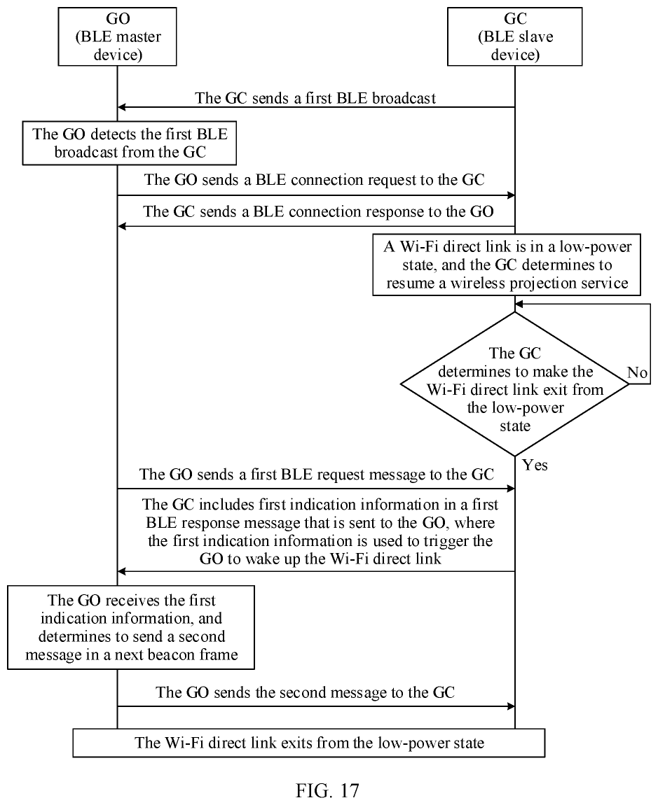

For example, as shown in FIG. 18, the GC sends the first BLE broadcast. The GO detects the first BLE broadcast from the GC, and discovers the GC. The GO sends, to the GC, the BLE GATT persistent connection request, which is used to request to establish the BLE GATT persistent connection. For example, the BLE GATT persistent connection request is a master device sending request (master send request). The GC replies, to the GO, with the BLE GATT persistent connection response, which is used to acknowledge the establishment of the BLE GATT persistent connection. For example, the BLE GATT persistent connection response is a slave device sending response (slave send response). The GO receives the BLE GATT persistent connection response and the BLE GATT persistent connection is successfully established. The GO, as the BLE master device, periodically sends first BLE request messages to the GC. Each time the GC receives the first BLE request message, the GC returns a first BLE response message to the GO.

If the sleep interval count in a beacon frame with an NOA sequence number 1 sent by the GO to the GC is greater than 0, the Wi-Fi direct link enters the low-power state. For example, in the beacon frame interval, if a mobile screen (GC) receives an operation of pressing a power button by a user, the GC determines to wake up the Wi-Fi direct link. The GC includes first indication information in a next first BLE response message for determining to wake up the Wi-Fi direct link. The first indication information is used to trigger the GO to wake up the Wi-Fi direct link. After the GO receives the first indication information, the sleep interval count in a next beacon frame (with an NOA sequence number 2) is equal to 0. In this way, after sending the beacon frame with the NOA sequence number 2, the GO exits from the low-power state of the Wi-Fi direct link. The GC receives the beacon frame with the NOA sequence number 2, and exits from the low-power state of the Wi-Fi direct link.

In this method, the GC establishes the BLE connection with the GO, the GO is the BLE master device, and the GC is the BLE slave device. The GC triggers the GO to wake up the Wi-Fi direct link by using the first indication information carried in the first BLE response message (the second request message). In the sleep window of the Wi-Fi direct link, the second request message may also be successfully sent and received In this way, the GC may also initiatively trigger wake-up of the Wi-Fi direct link, instead of waiting for the GO to wake up the Wi-Fi direct link. This reduces a latency in waking up the Wi-Fi direct link, and the wireless projection service may be resumed with a low latency. In addition, the sleep window may be set to relatively long duration, ensuring power consumption reduction. An interval at which the first BLE request messages are sent is set to a relatively small value, ensuring wake-up of the Wi-Fi direct link with the low latency.

In some other embodiments, a GC sends a second request message to a GO by using a BLE directed broadcast message.

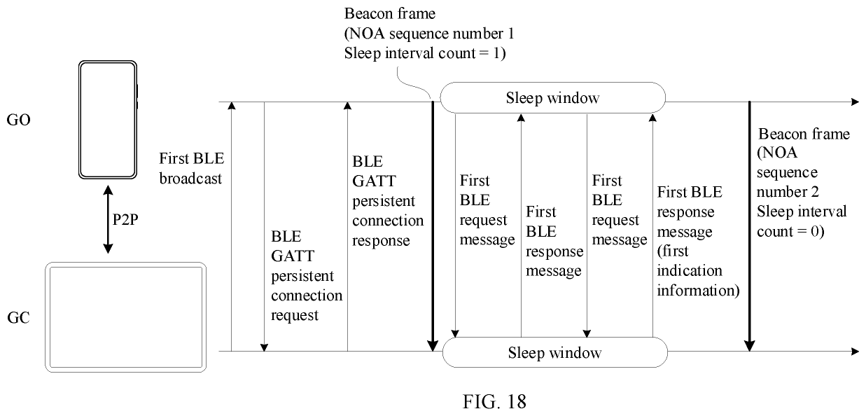

In an example, as shown in FIG. 19, a Wi-Fi direct link is in a low-power state, and the GC determines to resume a wireless projection service. The GC determines whether to exit from the low-power state of the Wi-Fi direct link. For example, if a screen of the GC is turned on, it is determined to exit from the low-power state of the Wi-Fi direct link. For another example, if an operation of pressing a power button by a user is received in a screen-off state, it is determined to exit from the low-power state of the Wi-Fi direct link. If it is determined to exit from the low-power state of the Wi-Fi direct link, the GC sends a first BLE directed broadcast (a destination address in the first BLE directed broadcast is an address of the GO) to the GO. The first BLE directed broadcast is used to trigger the GO to wake up the Wi-Fi direct link (to enable the Wi-Fi direct link to exit from the low-power state). The GO receives the first BLE directed broadcast, and determines to send a second message in a next beacon (beacon) frame. At a time point of sending a next beacon frame, the GO sends the second message to the GC, and exits from the low-power state of the Wi-Fi direct link. The GC receives the second message and exits from the low-power state of the Wi-Fi direct link. When the Wi-Fi direct link exits from the low-power state, the wireless projection service may be resumed for data transmission.

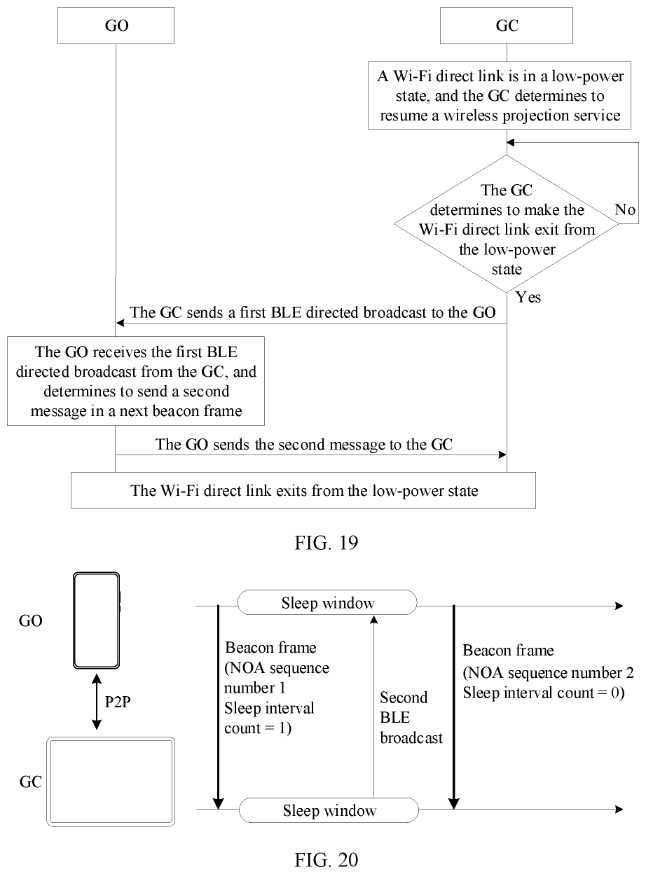

For example, as shown in FIG. 20, a sleep interval count in a beacon frame with an NOA sequence number 1 sent by the GO to the GC is greater than 0, and the Wi-Fi direct link enters the low-power state. For example, in the beacon frame interval, if a mobile screen (GC) receives an operation of pressing a power button by a user, the GC determines to wake up the Wi-Fi direct link. The GC sends, to the GO, the first BLE directed broadcast, which is used to trigger the GO to wake up the Wi-Fi direct link. After the GO receives the first BLE directed broadcast, the sleep interval count in a next beacon frame (with an NOA sequence number 2) is equal to 0. In this way, after sending the beacon frame with the NOA sequence number 2, the GO exits from the low-power state of the Wi-Fi direct link. The GC receives the beacon frame with the NOA sequence number 2, and exits from the low-power state of the Wi-Fi direct link.

In this method, the GC and GO do not need to establish a BLE connection. The GC triggers the GO to wake up the Wi-Fi direct link by using the BLE directed broadcast (the second request message). In a sleep window of the Wi-Fi direct link, the second request message may also be successfully sent and received In this way, the GC may also initiatively trigger wake-up of the Wi-Fi direct link, instead of waiting for the GO to wake up the Wi-Fi direct link. This reduces a latency in waking up the Wi-Fi direct link, and the wireless projection service may be resumed with a low latency. In addition, the sleep window may be set to relatively long duration, which not only ensures power consumption reduction, but also does not affect wake-up of the Wi-Fi direct link with the low latency.

In some other embodiments, a GC sends a second request message to a GO in a non-sleep window of a low-power state.

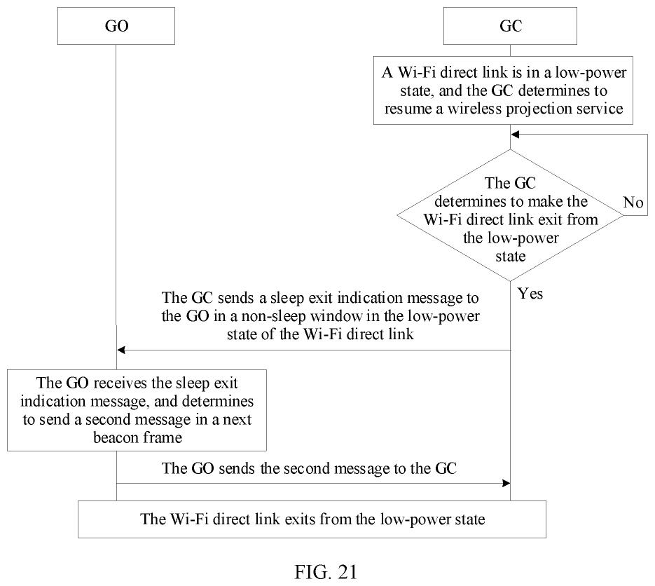

In an example, as shown in FIG. 21, a Wi-Fi direct link is in a low-power state, and the GC determines to resume a wireless projection service. The GC determines whether to exit from the low-power state of the Wi-Fi direct link. For example, if a screen of the GC is turned on, it is determined to exit from the low-power state of the Wi-Fi direct link. For another example, if an operation of pressing a power button by a user is received in a screen-off state, it is determined to exit from the low-power state of the Wi-Fi direct link. If it is determined to exit from the low-power state of the Wi-Fi direct link, the GC sends a sleep exit indication message (a second request message) to the GO in a non-sleep window in the low-power state of the Wi-Fi direct link. The sleep exit indication message is used to trigger the GO to wake up the Wi-Fi direct link (to enable the Wi-Fi direct link to exit from the low-power state). The GO receives the sleep exit indication message, and determines to send a second message in a next beacon (beacon) frame. At a time point of sending a next beacon frame, the GO sends the second message to the GC, and exits from the low-power state of the Wi-Fi direct link. The GC receives the second message and exits from the low-power state of the Wi-Fi direct link. When the Wi-Fi direct link exits from the low-power state, the wireless projection service may be resumed for data transmission.

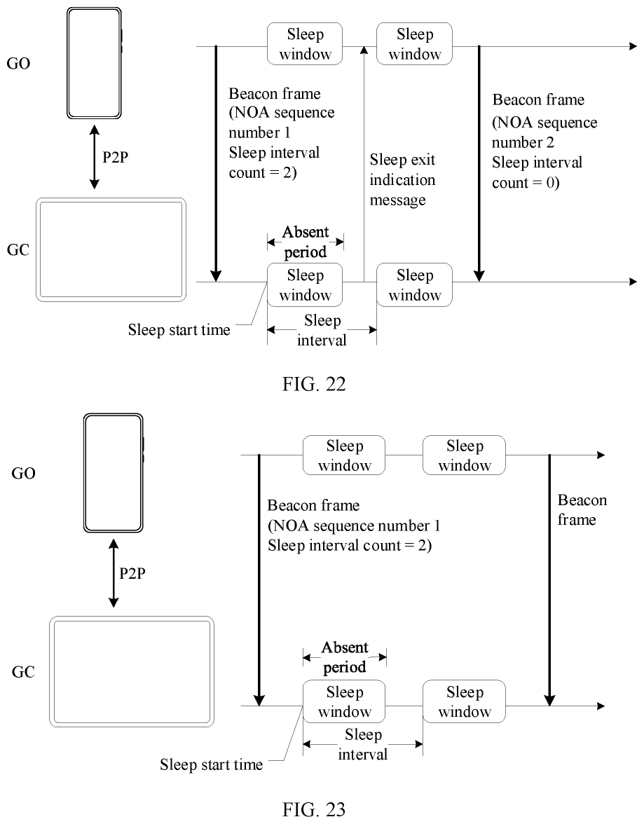

For example, as shown in FIG. 22, a sleep interval count in a beacon frame with an NOA sequence number 1 sent by the GO to the GC is greater than 0, and the Wi-Fi direct link enters the low-power state. For example, in the beacon frame interval, if a mobile screen (GC) receives an operation of pressing a power button by a user, the GC determines to wake up the Wi-Fi direct link. The GC sends in the non-sleep window, to the GO, the sleep exit indication message, which is used to trigger the GO to wake up the Wi-Fi direct link. After the GO receives the sleep exit indication message, the sleep interval count in a next beacon frame (with an NOA sequence number 2) is equal to 0. In this way, after sending the beacon frame with the NOA sequence number 2, the GO exits from the low-power state of the Wi-Fi direct link. The GC receives the beacon frame with the NOA sequence number 2, and exits from the low-power state of the Wi-Fi direct link.

In an implementation, the sleep exit indication message is a link layer message. For example, the GC sends a second management (action) frame to the GO. The second action frame is used to trigger the GO to wake up the Wi-Fi direct link. For example, the second management (action) frame is a custom action frame in the 802.11 protocol.

In another implementation, the sleep exit indication message is a service layer message, and is sent through a transfer control protocol (transfer control protocol, TCP) or a user datagram protocol (user datagram protocol, UDP) service channel.

In this method, the GC sends the sleep exit indication message (the second request message) to the GO to trigger the GO to wake up the Wi-Fi direct link. In this way, the GC may also initiatively trigger wake-up of the Wi-Fi direct link, instead of waiting for the GO to wake up the Wi-Fi direct link. This reduces a latency in waking up the Wi-Fi direct link, and the wireless projection service may be resumed with a low latency. For example, the sleep exit indication message is a link layer message or a service layer message. The sleep exit indication message cannot be sent in a sleep window of the Wi-Fi direct link, and may be successfully sent and received in a non-sleep window of the Wi-Fi direct link. In this method, the second request message is sent in the non-sleep window in the low-power state of the Wi-Fi direct link, to trigger the GO to wake up the Wi-Fi direct link; and even if the GO and the GC do not support BLE, the GC may also initiatively trigger wake-up of the Wi-Fi direct link.

The Wi-Fi link sleep and wake-up method provided in embodiments of this application not only supports the GO to initiatively enable the Wi-Fi direct link, and wake up the Wi-Fi direct link, but also supports the GC to initiatively trigger to enable Wi-Fi direct link sleep, and wake-up Wi-Fi direct link. Compared with a solution in which only the GO may initiatively enable Wi-Fi direct link sleep and wake up the Wi-Fi direct link, in the Wi-Fi link sleep and wake-up method provided in embodiments of this application, the GC does not need to wait for the GO, initiatively enables Wi-Fi direct link sleep, and wakes up the Wi-Fi direct link. This can wake up the Wi-Fi direct link with the low latency, and ensure low power consumption of the Wi-Fi direct link.

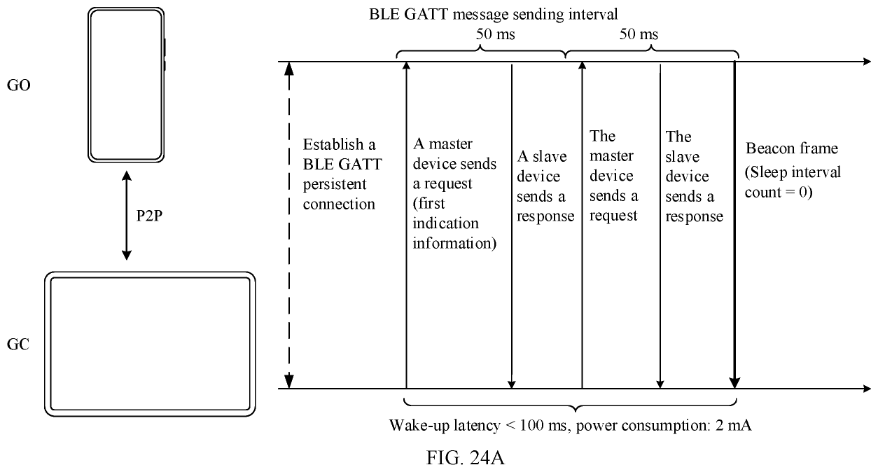

For example, if only the GO is supported to initiatively enable Wi-Fi direct link sleep and wake up the Wi-Fi direct link, the Wi-Fi direct link wake-up latency and power consumption may be adjusted by adjusting a proportion of the sleep window and the non-sleep window in the low-power state of the Wi-Fi direct link. As shown in FIG. 23, the GO periodically sends beacon frames to the GC. A sleep interval count in a beacon frame with an NOA sequence number 1 is 2, and the Wi-Fi direct link enters the low-power state, and includes two sleep windows.

In an implementation, the proportion of the sleep window and the non-sleep window is adjusted, and a beacon interval is set to 100 ms. For example, in a beacon interval, a working window occupies 1 ms, and average power consumption in the working window is 60 mA. When the beacon interval arrives, a sleep process latency in waking up the Wi-Fi direct link by the GO is 12 ms, and average power consumption is 30 mA. An absent period is 87 ms, and average power consumption in the sleep window is 0.2 mA. In the beacon interval, total power consumption is about 4.4 mA (60*1%+30*12%+0.2*87%), the GC may only wait for the GO to wake up the Wi-Fi direct link when the beacon interval arrives, and a maximum wake-up latency is about 100 ms.

In another implementation, the proportion of the sleep window and the non-sleep window is adjusted, and a beacon interval is set to 500 ms. For example, in a beacon interval, a working window occupies 1 ms, and average power consumption in the working window is 60 mA. When the beacon interval arrives, a sleep process latency in waking up the Wi-Fi direct link by the GO is 12 ms, and average power consumption is 30 mA. An absent period is 487 ms, and average power consumption in the sleep window is 0.2 mA. In the beacon interval, total power consumption is about 1.0 mA, the GC may only wait for the GO to wake up the Wi-Fi direct link when the beacon interval arrives, and a maximum wake-up latency is about 500 ms.

In the foregoing two implementations, if the sleep interval is set to a relatively short value, a latency in waking up the Wi-Fi direct link is low, but power consumption is high. If the sleep interval is set to a relatively long value, a latency in waking up the Wi-Fi direct link is high, but power consumption is low. It may be understood that, if only the GO is supported to initiatively enable Wi-Fi direct link sleep and wake up the Wi-Fi direct link, low power consumption and low-latency wake-up cannot be met at the same time.

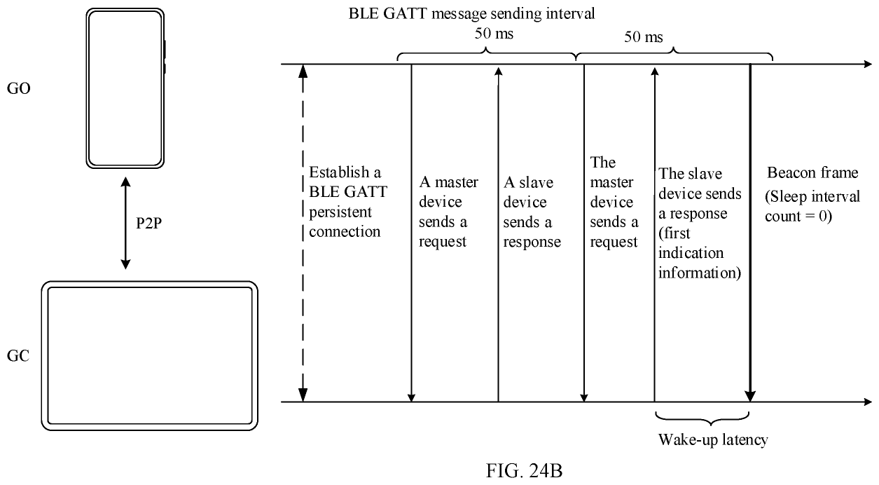

For example, in the Wi-Fi link sleep and wake-up method provided in embodiments of this application, the GC establishes the BLE connection with the GO, and the GC sends the BLE connection message to the GO, to trigger the GO to wake up the Wi-Fi direct link. As shown in FIG. 24A, after the GO (mobile phone) and the GC (mobile screen) are close, the BLE GATT persistent connection is established. The GC is the BLE master device, and the GO is the BLE slave device. It takes about 300 ms to establish the BLE GATT persistent connection. The connection is automatically established when the GO (mobile phone) and the GC (mobile screen) are close to each other, which does not affect the Wi-Fi direct link wake-up latency. A BLE GATT persistent connection link maintains power consumption of about 2 mA. When determining to exit from a low-power mode, the GC uses a BLE GATT message to notify the GO to trigger wake-up of the Wi-Fi direct link. For example, the master device sending request sent by the GC to the GO includes the first indication information. In the next beacon frame, the GO wakes up the Wi-Fi direct link. The Wi-Fi direct link wake-up latency is a latency between a time when the GC sends the master device sending request (including the first indication information) to the GO and a time when the next beacon frame is sent. For example, an interval at which the BLE GAT messages are periodically sent is 50 ms, and a beacon interval is 100 ms. In the scenario shown in FIG. 24A, duration from a time when the GC notifies the GO to trigger wake-up of the Wi-Fi direct link by using the BLE GATT message to a time when a next beacon interval arrives is less than two BLE GATT message sending intervals (that is, less than one beacon interval), and a maximum latency in waking up the Wi-Fi direct link is less than 100 ms. In some other scenarios, for example, as shown in FIG. 24B, after the GO (mobile phone) and the GC (mobile screen) are close, the BLE GATT persistent connection is established. The GO is the BLE master device, and the GC is the BLE slave device. When determining to exit from the low-power mode, the GC uses a BLE GATT message to notify the GO to trigger wake-up of the Wi-Fi direct link. For example, the slave device sending response sent by the GC to the GO includes the first indication information. In the next beacon frame, the GO wakes up the Wi-Fi direct link. The Wi-Fi direct link wake-up latency is a latency between a time when the GC sends the slave device sending response (including the first indication information) to the GO and a time when the next beacon frame is sent. A minimum latency in waking up the Wi-Fi direct link is close to 0.

In the scenarios shown in FIG. 24A and FIG. 24B, a maximum latency in waking up the Wi-Fi direct link is less than 100 ms, a minimum latency in waking up the Wi-Fi direct link is close to 0, and the BLE GATT persistent connection link maintains power consumption of about 2 mA. This can ensure low-latency wake-up of the Wi-Fi direct link and low power consumption.

It may be understood that, to implement the foregoing functions, the source device and the receiving device include corresponding hardware structures and/or software modules for performing the functions. A person skilled in the art needs to be easily aware that, in combination with the examples described in embodiments disclosed in this specification, units and algorithm steps may be implemented by hardware or a combination of hardware and computer software in embodiments of this application. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of embodiments of this application.

In embodiments of this application, the source device and the receiving device may be divided into functional modules based on the foregoing method examples. For example, each functional module may be obtained through division based on each corresponding function, or two or more functions may be integrated into one processing module. The integrated module may be implemented in a form of hardware, or may be implemented in a form of a software functional module. It needs to be noted that, in embodiments of this application, module division is an example, and is merely logical function division. In an actual implementation, another division manner may be used.

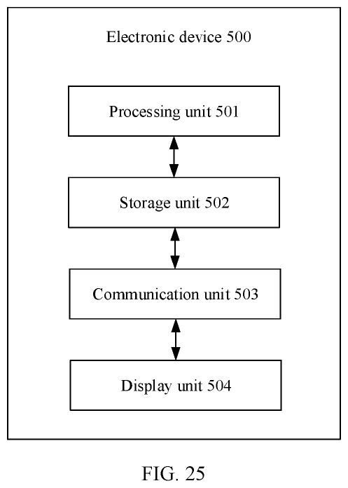

As shown in FIG. 25, an embodiment of this application discloses an electronic device 500. The electronic device may be the source device or the receiving device in the foregoing embodiments.

In an example, FIG. 25 is a schematic diagram of a possible structure of the electronic device in the foregoing embodiments. The electronic device 500 includes a processing unit 501, a storage unit 502, a communication unit 503, and a display unit 504. The processing unit 501 is configured to control and manage an action of the electronic device 500. The storage unit 502 is configured to store program code and data of the electronic device 500. The communication unit 503 is configured to support the electronic device 500 in communicating with another electronic device. The display unit 504 is configured to display an interface of the electronic device 500.

Certainly, unit modules in the electronic device 500 include but are not limited to the processing unit 501, the storage unit 502, the communication unit 503, and the display unit 504. For example, the electronic device 500 may further include a power supply unit. The power supply unit is configured to supply power to the electronic device 500.

The processing unit 501 may be a processor or a controller, for example, may be a central processing unit (central processing unit, CPU), a digital signal processor (digital signal processor, DSP), an application-specific integrated circuit (application-specific integrated circuit, ASIC), a field programmable gate array (field programmable gate array, FPGA) or another programmable logic device, a transistor logic device, a hardware component, or any combination thereof. The storage unit 502 may be a memory. The communication unit 503 may be a transceiver, a transceiver circuit, or the like. The display unit 504 may a display.

For example, the processing unit 501 is a processor (the processor 110 shown in FIG. 3), the storage unit 502 may be a memory (the internal memory 121 shown in FIG. 3), the communication unit 503 may be referred to as a communication interface, and includes a wireless communication module (the wireless communication module 160 shown in FIG. 3), and the display unit 504 is a display (the display 150 shown in FIG. 3, where the display 150 may be a touchscreen, and a display panel and a touch panel may be integrated into the touchscreen). The electronic device 500 provided in an embodiment of this application may be the electronic device 300 shown in FIG. 3. The processor, the memory, the communication interface, the display, and the like may be connected together, for example, connected through a bus.

An embodiment of this application further provides a computer-readable storage medium. The computer-readable storage medium stores computer program code. When a processor executes the computer program code, an electronic device performs the method in the foregoing embodiments.

An embodiment of this application further provides a computer program product. When the computer program product is run on a computer, the computer is enabled to perform the method in the foregoing embodiments.

The electronic device 500, the computer-readable storage medium, and the computer program product provided in embodiments of this application each are configured to perform the corresponding methods provided above. Therefore, for beneficial effects that can be achieved by the electronic device 500, the computer-readable storage medium, and the computer program product, refer to the beneficial effects in the corresponding methods provided above. Details are not described herein again.

The foregoing description about the implementations allows a person skilled in the art to clearly understand that, for the purpose of convenient and brief description, division into merely the foregoing functional modules is used as an example for description. During actual application, the foregoing functions can be allocated to different functional modules for implementation as required. In other words, an inner structure of an apparatus is divided into different functional modules to implement all or some of the functions described above.

In the several embodiments provided in this application, it needs to be understood that the disclosed apparatus and method may be implemented in other manners. For example, the described apparatus embodiment is merely an example. For example, the module or unit division is merely logical function division and may be other division during actual implementation. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or the units may be implemented in electrical, mechanical, or other forms.

In addition, functional units in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions in embodiments of this application essentially, or the part contributing to the conventional technology, or all or some of the technical solutions may be implemented in the form of a software product. The software product is stored in a storage medium and includes several instructions for instructing a device (which may be a single-chip microcomputer, a chip, or the like) or a processor (processor) to perform all or some of the steps of the methods described in embodiments of this application. The foregoing storage medium includes any medium that can store program code, like a USB flash drive, a removable hard disk, a ROM, a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1-29. (canceled)

30. A method, comprising:
receiving, by a first electronic device, a first request message, wherein the first electronic device establishes a wireless fidelity (Wi-Fi) direct link with a second electronic device, the first electronic device is a group owner (GO) of Wi-Fi Direct, the second electronic device is a group client (GC) of Wi-Fi Direct, and the first request message is used to trigger the first electronic device to enable Wi-Fi link sleep;
sending, by the first electronic device, a first message to the second electronic device, wherein the first message comprises at least one of a sleep interval count, a sleep start time, an absent period, or a sleep interval, the sleep interval count indicates a quantity of times the Wi-Fi link enters a sleep window in a current sleep process, the Wi-Fi link does not perform data transmission in the sleep window, the sleep start time indicates a start moment at which the Wi-Fi link enters the sleep window for a first time in the current sleep process, the absent period indicates duration in which the Wi-Fi link remains in the sleep window in the current sleep process, and the sleep interval indicates a time interval at which the Wi-Fi link enters the sleep window in the current sleep process; and
entering, by the first electronic device, a Wi-Fi link sleep state based on at least one of the sleep interval count, the sleep start time, the absent period, or the sleep interval.

31. The method according to claim 30, wherein the first request message is a link layer message or a service layer message.

32. The method according to claim 31, wherein the link layer message is a first management frame.

33. The method according to claim 31, wherein the service layer message is a screen projection suspension request message, and the screen projection suspension request message is used to request to suspend transmission of wireless projection data.

34. The method according to claim 30, wherein the first message is a first beacon frame, and the sleep interval count is greater than 0.

35. The method according to claim 30, wherein sending, by the first electronic device, the first message to the second electronic device comprises:
sending, by the first electronic device, the first message to the second electronic device in a next beacon frame interval after the first request message is received.

36. A method, comprising:
sending, by a second electronic device, a first request message to a first electronic device, wherein the second electronic device establishes a wireless fidelity (Wi-Fi) direct link with the first electronic device, the first electronic device is a group owner (GO) of Wi-Fi Direct, the second electronic device is a group client (GC) of Wi-Fi Direct, and the first request message is used to trigger the first electronic device to enable Wi-Fi link sleep;
receiving, by the second electronic device, a first message, wherein the first message comprises at least one of a sleep interval count, a sleep start time, an absent period, or a sleep interval, the sleep interval count indicates a quantity of times the Wi-Fi link enters a sleep window in a current sleep process, the Wi-Fi link does not perform data transmission in the sleep window, the sleep start time indicates a start moment at which the Wi-Fi link enters the sleep window for a first time in the current sleep process, the absent period indicates duration in which the Wi-Fi link remains in the sleep window in the current sleep process, and the sleep interval indicates a time interval at which the Wi-Fi link enters the sleep window in the current sleep process; and
entering, by the second electronic device, a Wi-Fi link sleep state based on at least one of the sleep interval count, the sleep start time, the absent period, or the sleep interval.

37. The method according to claim 36, wherein the first request message is a link layer message or a service layer message.

38. The method according to claim 37, wherein the link layer message is a first management frame.

39. The method according to claim 37, wherein the service layer message is a screen projection suspension request message, and the screen projection suspension request message is used to request to suspend transmission of wireless projection data.

40. The method according to claim 36, wherein the first message is a first beacon frame, and the sleep interval count is greater than 0.

41. The method according to claim 36, wherein before sending, by the second electronic device, the first request message to the first electronic device, the method further comprises:
turning off a screen of the second electronic device.

42. An electronic device, wherein the electronic device is a first electronic device, the first electronic device establishes a wireless fidelity (Wi-Fi) direct link with a second electronic device, the first electronic device is a group owner (GO) of Wi-Fi Direct, and the second electronic device is a group client (GC) of Wi-Fi Direct, the electronic device comprising:
at least one processor; and
at least one memory, wherein the at least one memory stores one or more computer programs, the one or more computer programs comprise instructions, and when the instructions are executed by the at least one processor, the electronic device is enabled to perform operations comprising:
receiving a first request message, wherein the first request message is used to trigger the first electronic device to enable Wi-Fi link sleep;
sending a first message to the second electronic device, wherein the first message comprises at least one of a sleep interval count, a sleep start time, an absent period, or a sleep interval, the sleep interval count indicates a quantity of times the Wi-Fi link enters a sleep window in a current sleep process, the Wi-Fi link does not perform data transmission in the sleep window, the sleep start time indicates a start moment at which the Wi-Fi link enters the sleep window for a first time in the current sleep process, the absent period indicates duration in which the Wi-Fi link remains in the sleep window in the current sleep process, and the sleep interval indicates a time interval at which the Wi-Fi link enters the sleep window in the current sleep process; and
entering a Wi-Fi link sleep state based on at least one of the sleep interval count, the sleep start time, the absent period, or the sleep interval.

43. The electronic device according to claim 42, wherein the first request message is a link layer message or a service layer message.

44. The electronic device according to claim 43, wherein the link layer message is a first management frame.

45. The electronic device according to claim 43, wherein the service layer message is a screen projection suspension request message, and the screen projection suspension request message is used to request to suspend transmission of wireless projection data.

46. The electronic device according to claim 42, wherein the first message is a first beacon frame, and the sleep interval count is greater than 0.

47. The electronic device according to claim 42, wherein sending the first message to the second electronic device comprises:
sending the first message to the second electronic device in a next beacon frame interval after the first request message is received.
